(19) United States
(12) Patent Application Publication
(10) Pub. No.: US 2012/0130731 A1
(43) Pub. Date: May 24, 2012

(54) SCHEDULED FUNDS TRANSFER PLATFORM APPARATUSES, METHODS AND SYSTEMS

(76) Inventor: Matt Steven Canetto, Centennial, CO (US)

(21) Appl. No.: 13/170,142

(22) Filed: Jun. 27, 2011

Related U.S. Application Data
(60) Provisional application No. 61/358,940, filed on Jun. 27, 2010.
(60) Provisional application No. 61/446,728, filed on Feb. 25, 2011.

(51) Int. Cl. G06Q 20/10; G06Q 50/22

(52) U.S. Cl. 705/2; 705/39

(57) ABSTRACT

The SCHEDULED FUNDS TRANSFER PLATFORM APPARATUSES, METHODS AND SYSTEMS (hereinafter “SFT PLATFORM”) transforms user account information, fund transfer configuration inputs via SFT PLATFORM components into fund transfer transaction record and fund transfer to a transfer-to account. In one embodiment, a method is disclosed, comprising: receiving a fund transfer scheduling request and fund transfer configuration parameters from a user, said fund transfer configuration parameters including a fund transfer trigger condition, a fund transferor's account and a fund transferee's account; verifying eligibility of the fund transfer scheduling request based on the fund transfer configuration parameters; determining the fund transfer trigger condition occurs; initiating a fund transfer transaction from the fund transferor's account to the fund transferee's account; and generating a fund transfer transaction record based on the initiated fund transfer transaction.

### RELATED APPLICATIONS

This application claims priority under 35 U.S.C. §119 to U.S. provisional patent application Ser. No. 61/358,940, filed on Jun. 27, 2010, entitled “Apparatuses, Methods And Systems For A Scheduled Funds Transfer Platform.”

The entire contents of the aforementioned application are herein expressly incorporated by reference.

### OTHER APPLICATIONS

This application claims priority under 35 U.S.C. §119 to U.S. provisional patent application Ser. No. 61/446,728, filed on Feb. 25, 2011, entitled “Apparatuses, Methods And Systems For A Healthcare Prepaid Payment Platform.”

The entire contents of the aforementioned application are herein expressly incorporated by reference

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present invention is directed generally to an apparatuses, methods, and systems for finance, and more particularly, to SCHEDULED FUNDS TRANSFER PLATFORM APPARATUSES, METHODS AND SYSTEMS.

### BACKGROUND

Fund transfer allows for the exchange or transfer of funds from one person, entity or account to another. Prepaid cards provide entities with a tenable means for carrying funds.

### SUMMARY

The SCHEDULED FUNDS TRANSFER PLATFORM APPARATUSES, METHODS AND SYSTEMS (hereinafter “SFT PLATFORM”) transforms user account information, fund transfer configuration inputs via SFT PLATFORM components into fund transfer transaction record and fund transfer to a transfer-to account. In one embodiment, a method is disclosed, comprising: receiving a fund transfer scheduling request and fund transfer configuration parameters from a user, said fund transfer configuration parameters including a fund transfer trigger condition, a fund transferor's account and a fund transferee's account; verifying eligibility of the fund transfer scheduling request based on the fund transfer configuration parameters; determining the fund transfer trigger condition occurs; initiating a fund transfer transaction from the fund transferor's account to the fund transferee's account; and generating a fund transfer transaction record based on the initiated fund transfer transaction

### BRIEF DESCRIPTION OF THE DRAWINGS

The accompanying appendices and/or drawings illustrate various non-limiting, example, inventive aspects in accordance with the present disclosure:

FIG. 1A-1C are of block diagrams illustrating data flows between the SFT PLATFORM and affiliated entities within embodiments of the SFT PLATFORM;

FIG. 2-4 are of process flow diagrams illustrating embodiments of the SFT PLATFORM;

FIGS. 5A-5S show exemplary screen images illustrating various embodiments and implementations of the SFT PLATFORM;

FIG. 6 is of a process flow diagram illustrating healthcare payment fund transfer within embodiments of the SFT PLATFORM;

FIG. 7A-7C show exemplary screen images illustrating mobile applications of scheduled fund transfer within embodiments of the SFT PLATFORM; and

FIG. 8 is of a block diagram illustrating embodiments of the SFT PLATFORM controller;

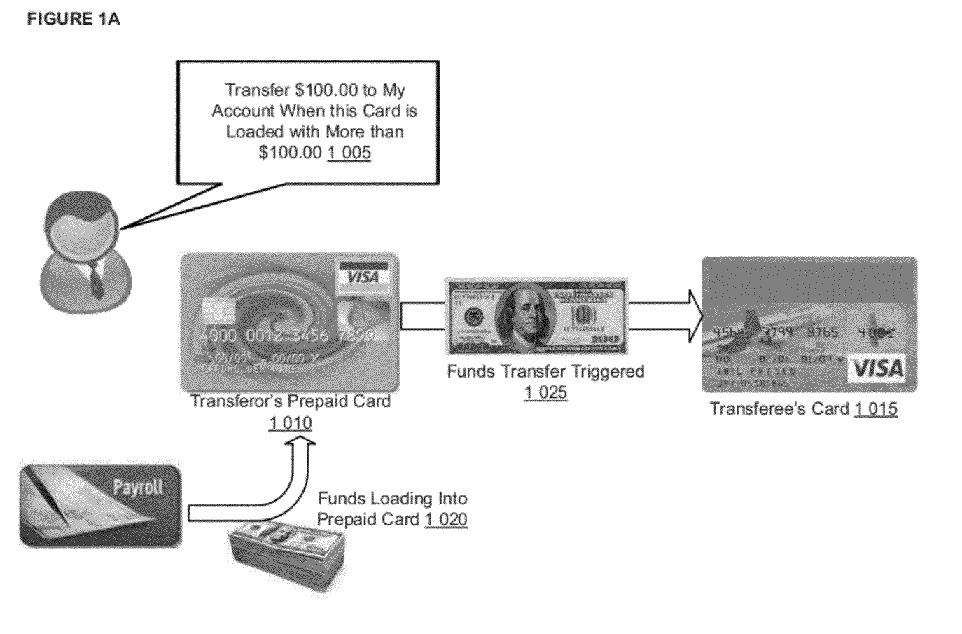

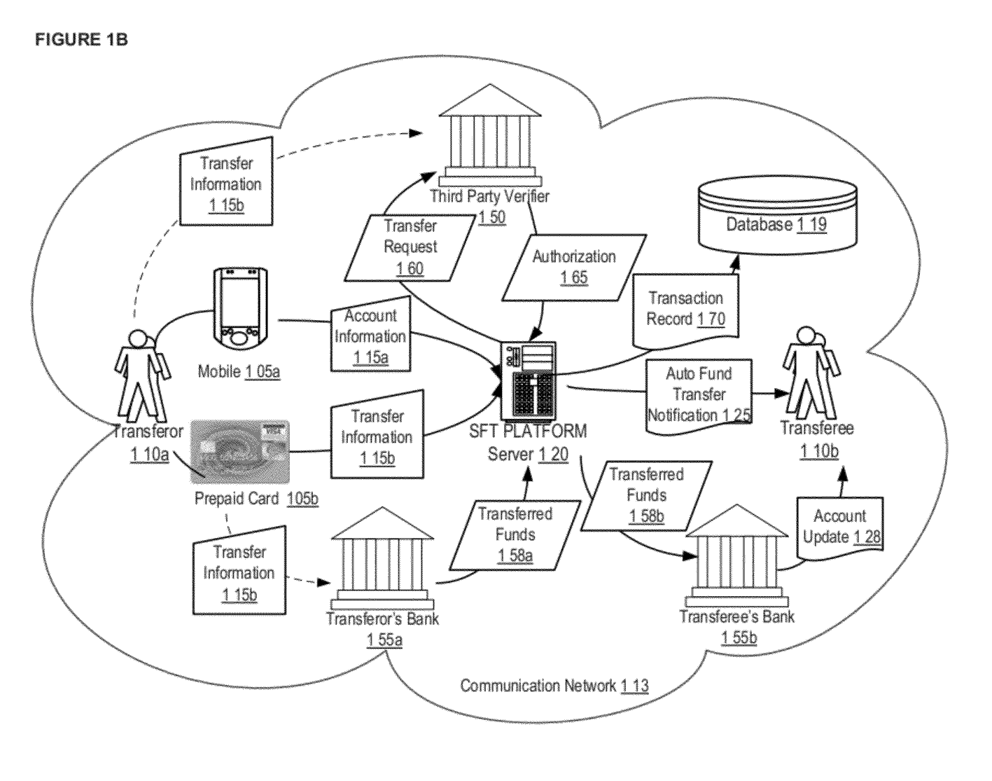

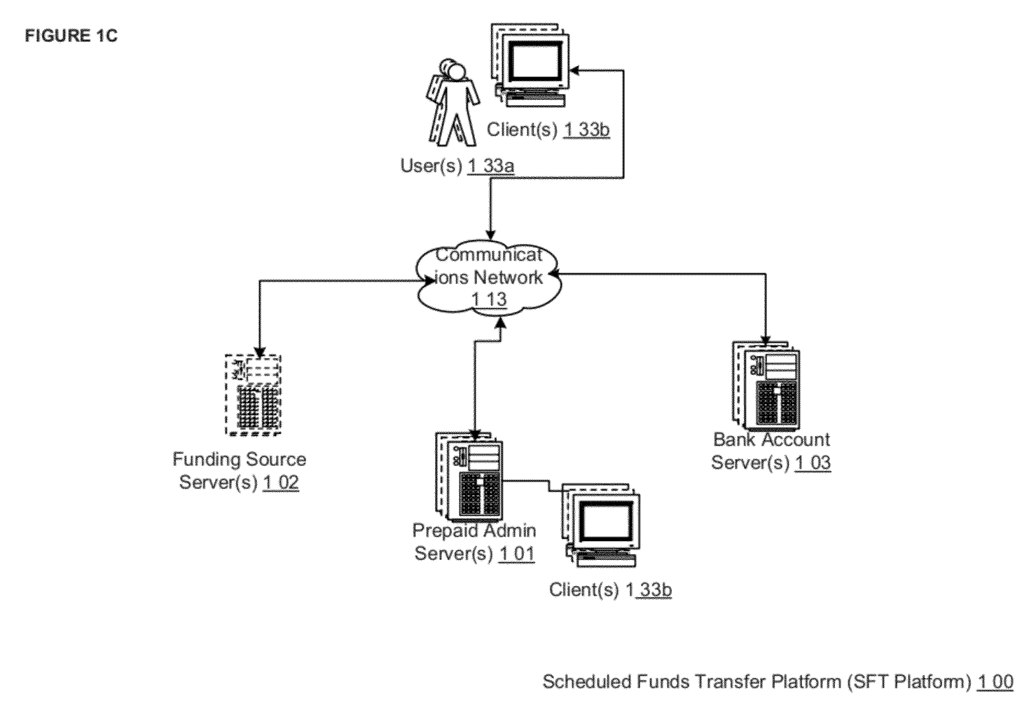

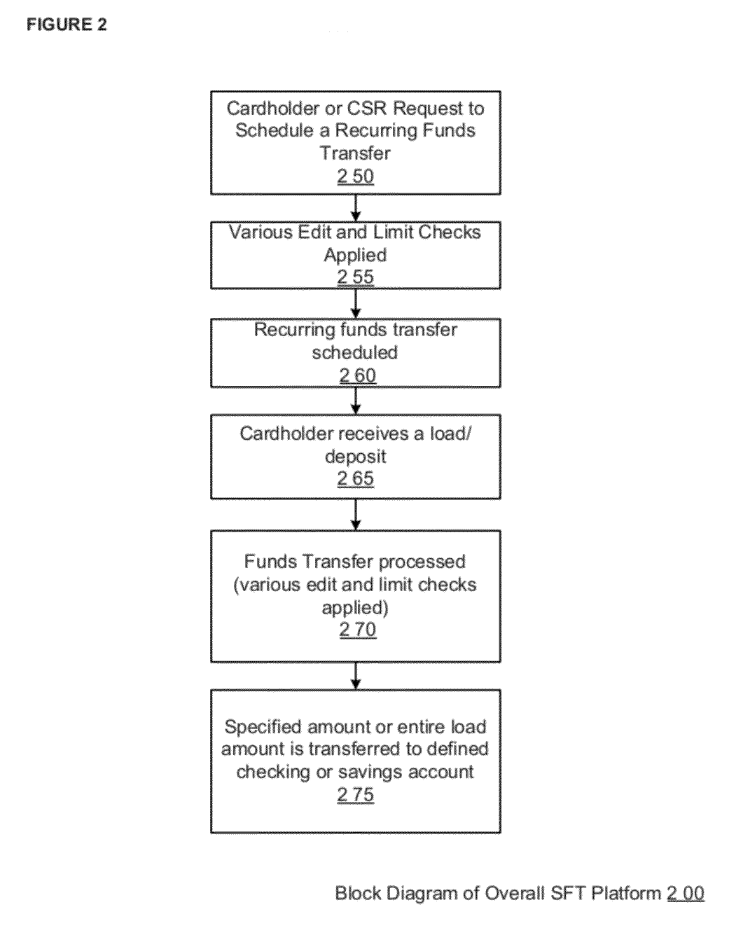

The leading number of each reference number within the drawings indicates the figure in which that reference number is introduced and/or detailed. As such, a detailed discussion of reference number 101 would be found and/or introduced in FIG. 1. Reference number 250 is introduced in FIG. 2, etc.

### DETAILED DESCRIPTION

This disclosure details apparatuses, methods and systems for a Scheduled Funds Transfer Platform (hereinafter, “SFT PLATFORM”) that delivers dynamic management and/or control of funds transfer capabilities and components. In particular this disclosure discusses the application of the SFT PLATFORM to provide cardholders with the ability to configure scheduled recurring funds transfers from their reloadable prepaid cards to a checking or savings account. Using the SFT PLATFORM, a cardholder may specify a given amount of a transfer to occur after a load or deposit is received on a prepaid card and/or may specify that an entire load/deposit amount be transferred after it has been received.

In some embodiments of the SFT PLATFORM, funds transfer describes the exchange or transfer of funds from one person, entity or account to another. In one embodiment, the funds transfer may be a transfer of funds from a prepaid account to an alternate account and may refer to a one-time immediate funds transfer or recurring funds transfer. One example of a prepaid account is an account maintained and processed by an issuer comprising at least one deposit. A deposit may be a load of funds to the prepaid account through various channels and funding sources. A one-time immediate funds transfer may be a single transfer of money at a selected value, from one person, entity or account to another.

Prepaid cards may be cards whose monetary value has been deposited with and processed by an issuer. The value of the card corresponds with a card number associated with data maintained by an issuer, in this regard, prepaid cards may be similar to debit cards. The monetary balance of the prepaid card may be maintained and processed by the issuer. Prepaid cards may be issued in the name of individual account holders, along with unique card numbers. Prepaid cards may also have the characteristics of “stored value” cards where the issued cardholder may be anonymous and the value of the card has been stored physically on the card.

The SFT PLATFORM may be used in a variety of applications including, but not limited to, payroll, commercial and General Purpose Reloadable (hereinafter “GPR”) card types, unemployment and disability imbursement services, gift cards, travel cards, and/or the like. The SFT PLATFORM may also be used in a variety of prepaid card systems including closed, semi-closed and open systems.

A “Transfer-to Account” or “Account” may be a prepaid cardholder's checking or savings that has been saved in the prepaid system in order to transfer funds from the prepaid account to the checking or savings account. A “One-Time Immediate Funds Transfer” may be an existing Funds Transfer facility in the prepaid system. A “Recurring Funds Transfer” or “Scheduled Transfer” may provide facilities that allow a cardholder or Customer Service Representative (hereinafter “CSR”) to schedule funds transfers to occur in the future (e.g., following a deposit to the prepaid account). A “Funds Transfer” or “Transfer” may be the transfer of funds from the prepaid account to the Transfer-to Account and may refer to either a one-time immediate funds transfer or a recurring funds transfer. A “Deposit” may be a load of funds to the prepaid account through various channels and funding sources.

It is understood that the SFT PLATFORM may be readily configured/customized for a wide range of other applications or implementations. Therefore the detailed embodiments of the SFT PLATFORM disclosed herein are merely illustrative, and not restrictive, of the invention that may be embodied in various forms. Furthermore, the examples given in connection to the various embodiments of the SFT PLATFORM are intended to be illustrative, and are not restrictive.

### SFT Platform

FIG. 1A provides a diagram illustrating an overview of the SFT PLATFORM within embodiments of the SFT PLATFORM. Within embodiments, as shown in FIG. 1A, a cardholder may possess a prepaid card 1010, e.g., a prepaid credit card, a prepaid debit card, etc., and configure the prepaid card for scheduled fund transfer to another bank account. In one implementation, the prepaid card 1010 may be sponsored by a variety of entities. For example, the prepaid card may be loaded with funds by an employer (e.g., payroll salary payment, etc.), healthcare insurance carriers (e.g., insurance payment of medical services, etc.), government agencies (e.g., tax refund, unemployment, social services, etc.), card issuers (e.g., deposits into the card, etc.), and/or the like.

For example, the cardholder may request a scheduled fund transfer from a transferor's prepaid card 1010, e.g., to transfer $100.00 to the transferee's card 1015 when the transferor's prepaid card 1010 is credited with more than $100.00 1005. The cardholder may submit account information of the transferor's account 1010 and transferee's card 1015, transfer amount (e.g., $100.00), transfer trigger condition (e.g., when the transferor's account is prepaid for more than $100.00), and/or the like to a SFT PLATFORM to establish the fund transfer. The transferor's prepaid card and the transferee's card may be associated with the same cardholder, as the cardholder may desire to transfer funds between his personal accounts. In another implementation, the transferor's account and the transferee's account may be associated with different individuals, as the transferor may be allowed to schedule fund transfer to another individual.

In one implementation, when the transferor's prepaid card 1010 is loaded, e.g., when the cardholder's payroll deposits the cardholder's monthly salary (which is greater than $100.00) into the transferor's prepaid card 1010, the scheduled fund transfer 1005 may be triggered 1025, and $100.00 may be automatically transferred to the transferee's card 1015.

FIG. 1B shows a block diagram illustrating various embodiments of the SFT PLATFORM. Within various embodiments, one or more fund transferors 110a, one or more fund transferees 110b, SFT PLATFORM server 120, SFT PLATFORM database(s) 119, a third party verifier 150, a pay, and/or advertising channels 130 are shown to interact via various communication network 113.

In one embodiment, a SFT PLATFORM user, who may be a fund transferor 110a, may access a SFT PLATFORM supported bank account via a SFT PLATFORM vehicle, such as, but not limited to a mobile device 105a, a prepaid bank card 105b, and/or the like. In one embodiment, the transferor 110a and a transferee 110b may be different persons and/or entities. For example, an employer's payroll may be a transferor who needs to transfer funds as the monthly salary to an employee (the transferee). In another embodiment, the transferor 110a and the transferee 110b may be the same entity. For example, a user may want to transfer funds from one account to another account.

In one implementation, the transferor 110a may submit information to the SFT PLATOFRM server 120 to set up automatic scheduled fund transfers. For example, the transferor 110a may submit the account information 115a (e.g., transferor's name, transferor's account number, transferor's account name, transferor's bank routing number, transferee's account number, transferee's bank routing number, etc.), transfer information 115b (e.g., transfer schedule, transfer amount, transfer verification procedure, etc.), and/or the like.

For example, in one implementation, an exemplary eXtensible Markup Language (XML) record of fund transfer configuration may include the account information 115a and the transfer information 115b, which may take a form similar to the following:

<TransferConfig>

<ConfigID> JK1222 </ConfigID>
<ConfigTime> 09:10:23 06-03-2000 </ConfigTime>
<ConfigSource> IP 000.000.00.000 </ConfigSource>
<ConfigLogin> Valid </ConfigLogin>
<UserName> John Smith </UserName>
<Password> 19001021 </Password>
<Transferor>

<TransferorName> John Smith </TransferorName>
<TransferorAccount> 0000 0000 0000 0000
</TransferorAccount>
<TransferorBankRoutingNo> 1111111
<TransferorBankRoutingNo>
...

</Transferor>
<Transferee>

<TransfereeName> John Smith </TransfereeName>
<TransfereeAccount> 0000 0000 0000 0003
</TransfereeAccount>
<TransfereeBankRoutingNo> 1111111
<TransfereeBankRoutingNo>
...

</Transferee>
<FundSource>

| | |
|---|---|
| <Source1> | Unemployment Aid </Source1> |
| <Source2> | Social Service </Source2> |
| <Source3> | Medical Aid </Source3> |

...

</FundSource>
<TriggerRule>

<TransferorAccountLoadMin> 500.00
</TransferorAccountLoadMin>
<TransferAmount> 30% </TransferAmount>
...

</TriggerRule>
<Restriction>

<TransferorRestriction>
...
<MaxAmount> 1000.00 </MaxAmount>
<MinTransferInterval> 24.00 hrs <MinTransferInterval>
</TransferorRestriction>
<RestrictionPerType>

| | |
|---|---|
| <Type> | Medical Insurance Payment </Type> |
| <Rule> | Verification Required </Rule> |

...
</RestrictionPerType>
<FundSourceRestriction>

<Source1>

<MaxAmount> 50% <MaxAmount>
<Restriction> transfer to another account
</Restriction>

</Source1>
<Source2>

<MaxAmount> 100.00 <MaxAmount>
<Restriction> alcohol </Restriction>

<Source2>
...

</FundSourceRestriction>
...

</Restriction>...
</Trigger>

</TransferConfig>

In the above example, the user “John Smith's” may schedule a transfer from his first bank account, e.g., a prepaid card with number “0000 0000 0000 0000” to another bank card “0000 0000 0000 0003.” The transfer may be triggered when the transferor's account (e.g., the prepaid account) has been loaded more than $500.00 funds, and in such cases 30% of the loaded amount is automatically transferred to the transferee's account. The user may also specify restrictions on the fund transfer to prevent fraudulent transfers. For example, the amount of the transfer may be capped by $1000.00 for one time, and two transfers may not happen within 24 hours. In one implementation, the SFT PLATFORM may impose such restrictions to protect SFT PLATOFRM cardholders, and a cardholder may vary the restrictions by providing customized parameters.

In further examples, the SFT PLATOFRM fund transfer may specify the fund source, e.g., the entities that load the transferor's prepaid card. In the above example, the transferor's card may be loaded by “Unemployment Aid,” “Social Service,” “Medical Aid.” The SFT PLATFORM may apply restriction on the fund allotted into the prepaid cards from the different fund sources. For example, at least 50% funds loaded by the “Unemployment Aid” may not be transferred to another account; at most “$100.00” amount from the funds loaded by the “Social Service” may not be transferred for alcohol purchase, and/or the like.

In another implementation, The SFT PLATFORM may restrict the fund transfer transaction based on its type. In the above example, the SFT PLATOFRM may request verification from a third party (e.g., insurance carrier) if the fund transfer is for a medical insurance payment.

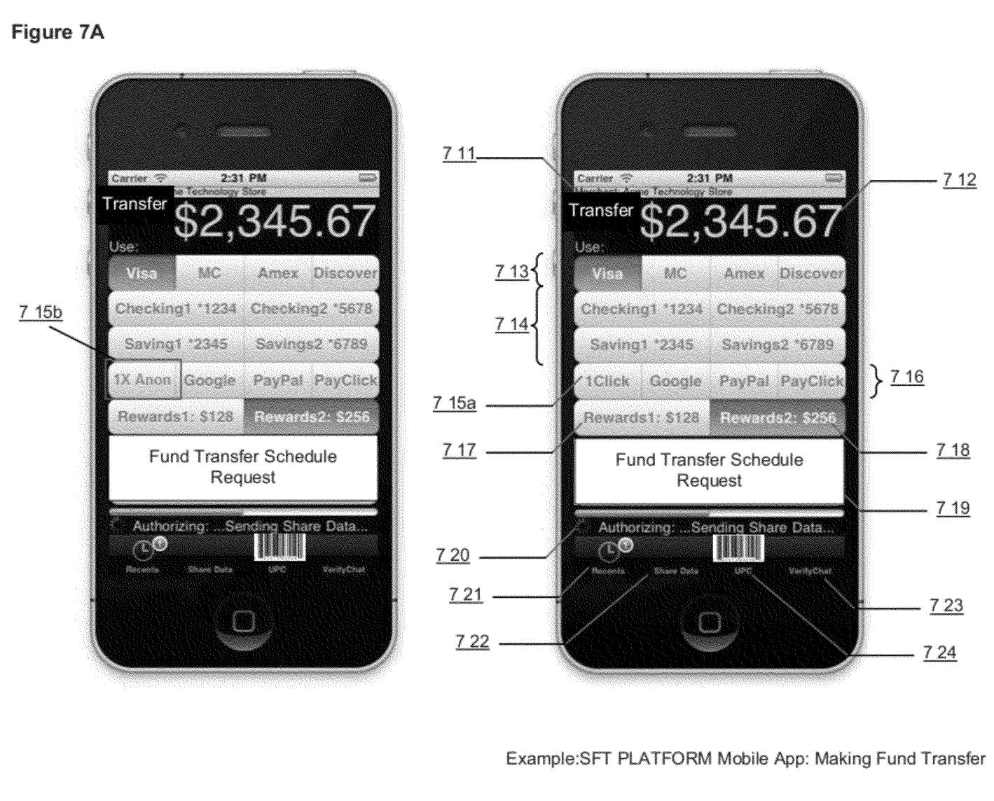

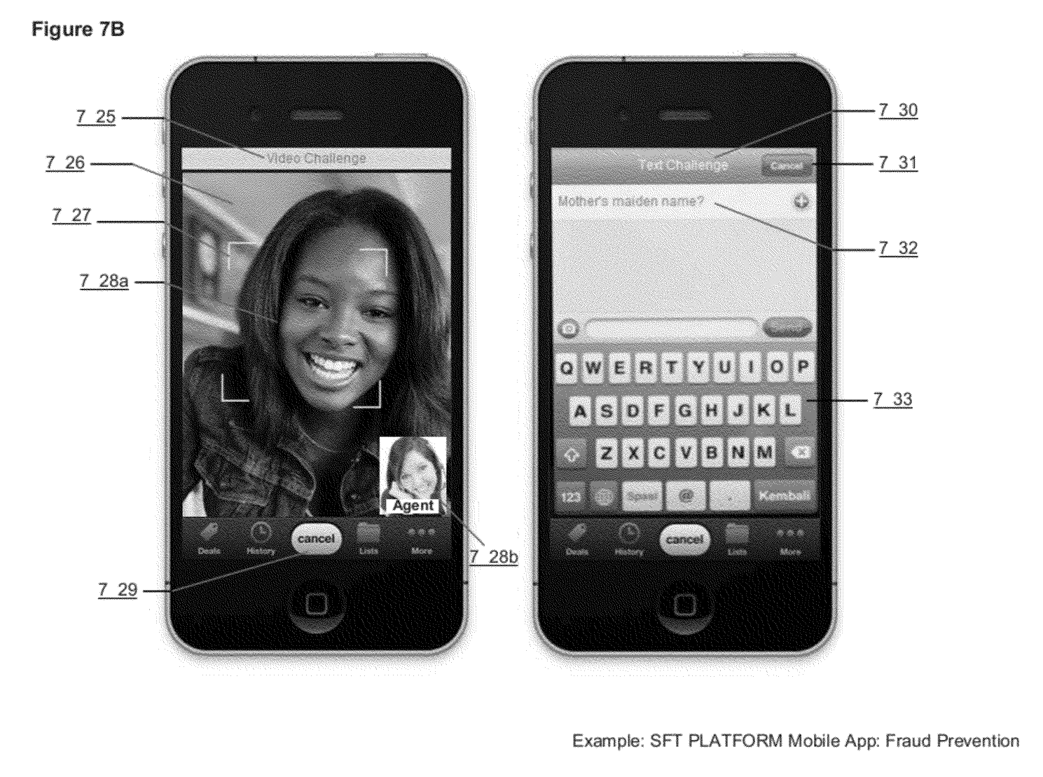

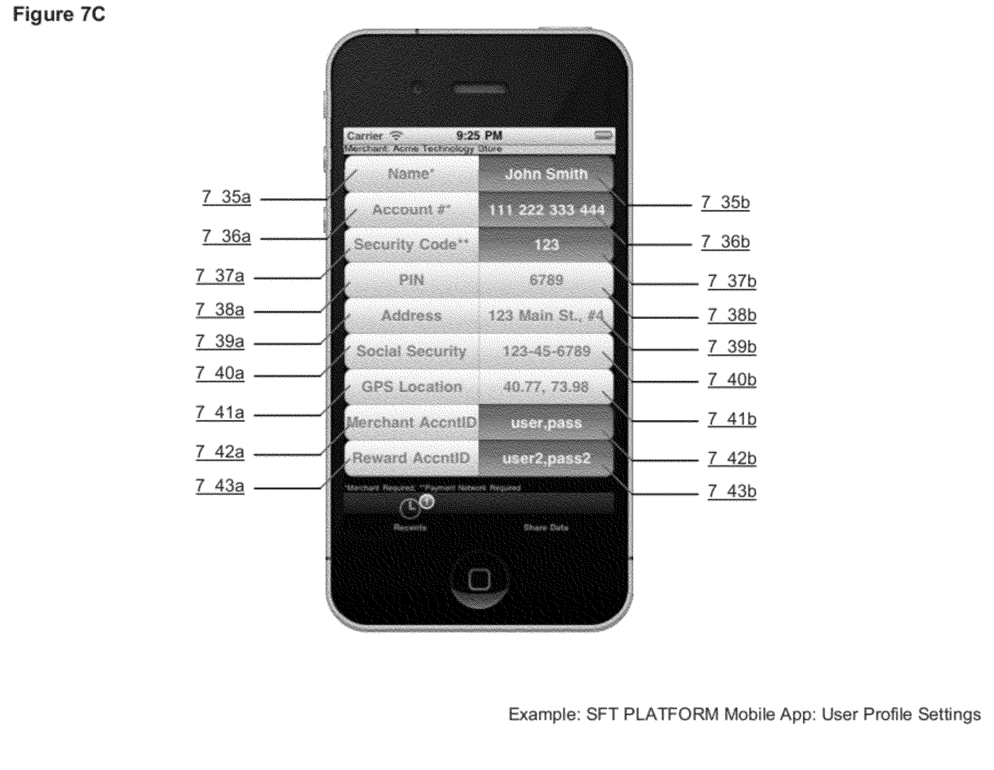

In one implementation, the transferor 110a may submit information via a mobile device 105a, e.g., via transferor's mobile electronic wallet (as further illustrated in FIGS. 7A-7C), and/or by providing prepaid card 105b information to the SFT PLATFORM server 120.

In one implementation, the transfer information 115b may comprise a user determined transfer schedule, transfer amount, transfer verification procedure, and/or the like. For example, in one implementation, the transferor may request an automatic transfer of a fixed amount of funds on a periodic basis (e.g., salary payment on the first day of every month, etc.). For another example, the transfer may be scheduled when the transferor's account is loaded, and a pre-determined amount, or a percentage of the loaded amount may be transferred.

In one embodiment, the SFT PLATFORM server 120 may be affiliated with, or housed at one of the transferor's bank 155a and the transferee's bank 155b. In another embodiment, the SFT PLATOFRM server 120 may be associated with an independent financial institution. In a further embodiment, the SFT PLATOFRM may comprise a plurality of distributed servers, e.g., an IBM J2EE platform, etc.

In one embodiment, when the scheduled fund transfer is triggered (e.g., periodically, or triggered by fund loading at the transferor's account), the transferred funds 158a may be submitted form the transferor's bank 155a to the SFT PLATFORM server 120, which may in turn verify and forward the fund transfer 158b to the transferee's bank 155b, e.g., the transferee's bank card, etc.

In one implementation, the fund transfer may require a third party verification. For example, the transferor 110a may be a patient who schedules automatic medical payment upon receiving medical treatment at a healthcare provider. The transferor 110a may submit transfer information 115b to a third party verifier 150, e.g., a healthcare insurance carrier, etc., before the scheduled medical treatment. For example, the transferor 110a may provide information such as the date of the medical treatment, the type of the medical treatment, and/or the like, to the insurance carrier to obtain pre-approval of automatic fund transfer. In that case, when the insurance carrier receives a transfer request 160, the insurance carrier may verify the received medical bill with the pre-approved transferor provided medical treatment information, and issue an authorization 165 of the automatic transfer.

In one embodiment, approval of fund transfer from a prepaid card to a designated transfer-to account may be determined by the SFT PLATOFRM based on a number of heuristics. For example, a whitelist of factors may comprise the approval of certain transaction identifiers, certain transaction type (e.g., salary payment, unemployment, social service, medical insurance, etc.), a combination of transaction type with other condition (e.g., allotted allocations per transaction type, a proportional or absolute allowance per a transaction type, etc.), and/or the like. For example, the SFT PLATFORM may allow 15% of allocated funds to be directed to medical payment based on transferor requirement, etc. In another implementation, the SFT PLATFORM may consider a blacklist of factors, such as blacklisting transaction identifiers, transaction conditions, and triggered combinations thereof, and/or the like. In addition, the fund source and/or transferor can restrict the fund transfer the allotted funds they provide to the cardholder. For example, the fund source (e.g., social service, etc.) may restrict an attempt of fund transfer to an account associated with an individual not eligible for social service aid.

For example, in one implementation, an exemplary XML record of transfer request 160 may take a form similar to the following:

<Request>

<RequestID> RQ00001 </RequestID>
<RequestSource> St Johns Hospital </RequestSource>
<PatientName>

John Smith

</PatientName>
<PatientID> JS123456 </PatientID>
<PatientAccount>

<AccountNo> 0000 0000 0000 0000 </AccountNo>
<BankRouting> 1111111 </BankRouting>
<BankName> Bank of ABC </BankName>
...

</PatientAccount>
<RequestSubmissionTime>

19:45 09-09-2013

</RequestSubmissionTime >
...
<Transferor>

<TransferorName> Dental ASD Provided </TransferorName>
<TransferorAccount> ... </TransferorAccount>
<TransferorBankRoutingNo> ... <TransferorBankRoutingNo>
...

</Transferor>
<Transferee>

<TransfereeName> ABC Dental </TransfereeName>
<TransfereeAccount> ... </TransfereeAccount>
<TransfereeBankRoutingNo> ... <TransfereeBankRoutingNo>
...

</Transferee>
<TransferAmount> 960.00 </TransferAmount>
<TriggerRule>

<RecordMatch> Yes </RecordMatch>

<RequestMatter>
<MatterID>
Dental00090909
</MatterID >
<MatterDate>
09-15-2013
</MatterDate >
<Matter>
root canal therapy
</Matter>
<MatterPrice> 1200.00 </MatterPrice>
<MatterCoverage>
80%
</Matter>
<Provider>
ABC Dental
</Provider>
...

<InsurnedAmountMaximum>

1500.00 </InsurnedAmountMaximum>

<AllowedAmount> 1000.00 </AllowedAmount>
</TriggerRule>
...

</Request>

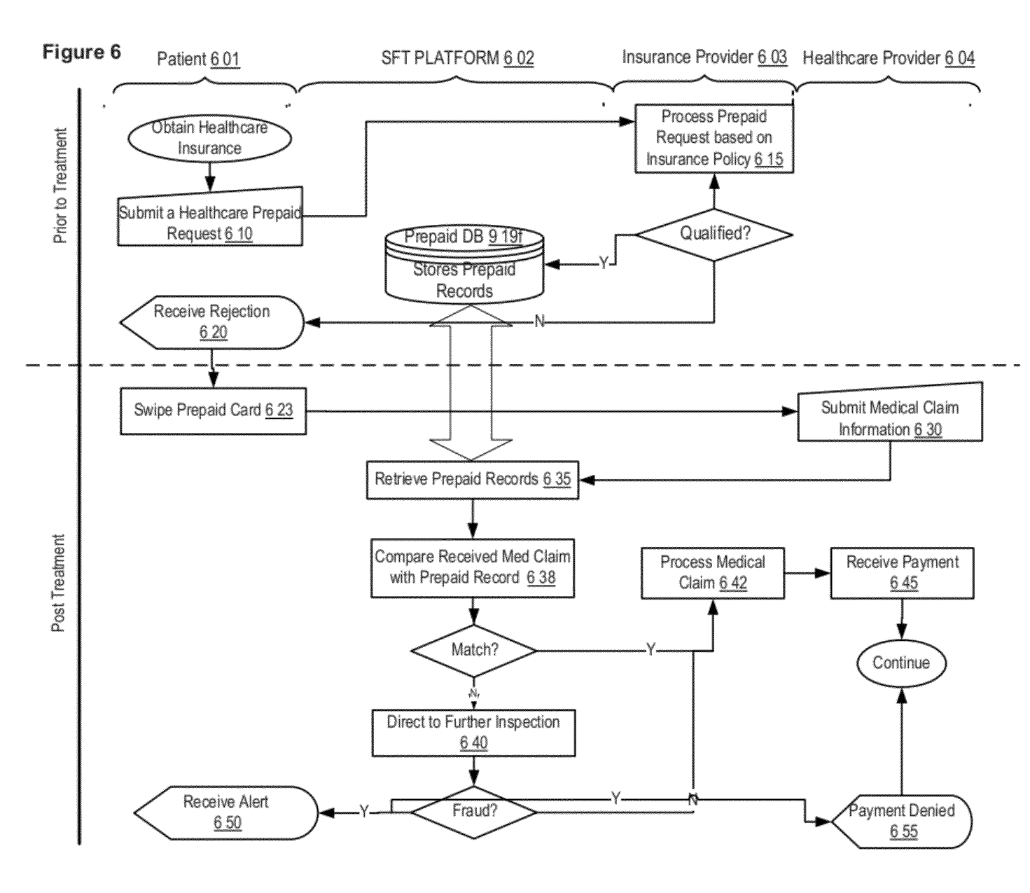

In the above example, the SFT PLATOFRM may forward a request for medical payment for the insured portion from an insurance carrier “Dental ASD Provided” to a healthcare provider “ABC Dental,” triggered when the request matter has been matched with the patient “John Smith's” previously scheduled medical treatment. For example, the third party verifier (e.g., the insurance carrier “Dental ASD Provided”) may verify that the patient “John Smith” previously scheduled to have a “root canal therapy” performed on “Sep. 15, 2013,” and upon verification the insurance carrier may authorize the scheduled fund transfer of the requested transfer amount “960.00” e.g., “80%” insurance coverage of the full price “1200.00,” to the transferee “ABC dental.” Further implementations of prepaid healthcare payment SFT PLATFORM are discussed in FIG. 6.

In one embodiment, the SFT PLATFORM server 120 may establish data records of registered users, transaction details 170 and/or the like for storage in a database 119. For example, in one implementation, the past transactions 170 may comprise information with regard to the transaction type (e.g., fund transfer between one's different accounts, interpersonal transfers, medical insurance payment, etc.), transaction timestamp, transferor's account number, transferee's account number, transferred amount, transfer trigger, and/or the like.

For example, an exemplary XML record of a transaction 170 may take a form similar to the following:

<Transaction>

<TransactionID> 123456789 </TranactionID>
<TransactionTime> 09:10:23 06-06-2000 </TransactionTime>
<TransactionAmount> 150.00 </TransactionAmount>
<Transferor>

<TransferorName> John Smith </TransferorName>
<TransferorAccount> 0000 0000 0000 0000
</TransferorAccount>
<TransferorBankRoutingNo> 1111111
<TransferorBankRoutingNo>
...

</Transferor>
<TransactionType> Same Person; Different Accounts
</TransactionType>
<Transferee>

<TransfereeName> John Smith </TransfereeName>
<TransfereeAccount> 0000 0000 0000 0003
</TransfereeAccount>
<TransfereeBankRoutingNo> 1111111
<TransfereeBankRoutingNo>
...

</Transferee>
<Trigger>

<TriggerTime> 09:10:15 06-06-2000 </TriggerTime>
<TriggerRule>

<TransferorAccountLoadMin> 500.00
</TransferorAccountLoadMin>
<TransferAmount> 30% </TransferAmount>
...

</TriggerRule>

...
</Trigger>
<Approval>

<Whitelist>

<TransactionID> 00001 </TransactionID>
<TransactionType> <Type1> Same Person; Different

Accounts <Type2>

</TransactionType>

...
</WhiteList>
<BlackList>
<TransactionID>00002 </TransactionID>

<TransactionType> <Type1> greater than 2000.00
<Type2>
</TransactionType>

...
</BlackList>

</Approval>
...

</Transaction>

In the above XML example, the scheduled transaction takes place from the user “John Smith's” account to his another account, wherein the transaction is triggered when the transferor's account is loaded more than $500.00 funds, and in such cases 30% of the loaded amount (e.g., $150.00 out of $500.00) is automatically transferred to the transferee's account.

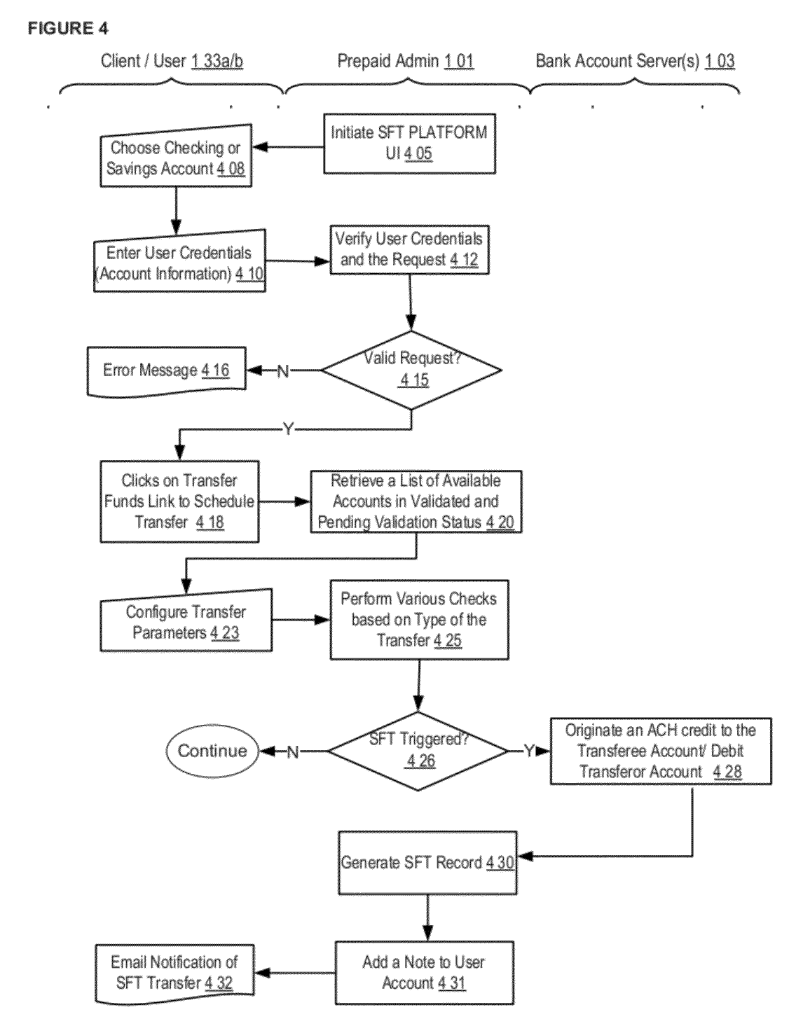

In another implementation, the transaction record 170 transferred funds 158a/158b, and/or the like may be performed by the SFT PLATFORM originated ACH files, as further illustrated in FIG. 4.

FIG. 1C provides an overview block diagram illustrating data flows between clients, users, servers and system administrators via a communication network for an embodiment of the SFT PLATFORM. In such an embodiment, a user or users may interact with an SFT PLATFORM server 101 through a communication network. It is to be understood that SFT PLATFORM server 101 is illustrated as a remote server by way of example only and that the SFT PLATFORM implementation may be customized based on the requirements of a particular Customer Service Representative (hereinafter “CSR”) or prepaid system administrator. User 133a may submit basic information and data values for processing through a user interface to the SFT PLATFORM server 101 and prepaid admin server 102 through a communication network. In another embodiment, SFT PLATFORM server 101 may be a local computer so that a CSR user may interact with it through user input devices (e.g. a keyboard, mouse, etc.) directly without remote access via a network. In yet another embodiment SFT PLATFORM server may be a local server in a Prepaid Admin System with Prepaid Admin Server(s) 102.

FIG. 2 provides a process flow diagram illustrating one embodiment of the SFT PLATFORM. It is to be understood the process illustrated in FIG. 2 are not restrictive and may be customized based on the requirements of various administrative users including, and not limited to, Prepaid Administration System (hereinafter “PAS”) administrators and bank account administrators. A cardholder or CSR 533 inputs requests to schedule recurring funds transfer 250 using a user interface device. Once received, various edits and limit checks are applied to the data comprising the request 255 and a recurring funds transfer is scheduled 260. The cardholder receives a load/deposit 265 and may receive a communications of said load/deposit from the SFT PLATFORM 101 or PAS 102. Meanwhile, the funds transfer may be processed including the application of various edits and limit checks 270. Once complete, the specified amount, as prescribed in the initial request, or the entire load amount may be transferred to a defined checking or savings account 275.

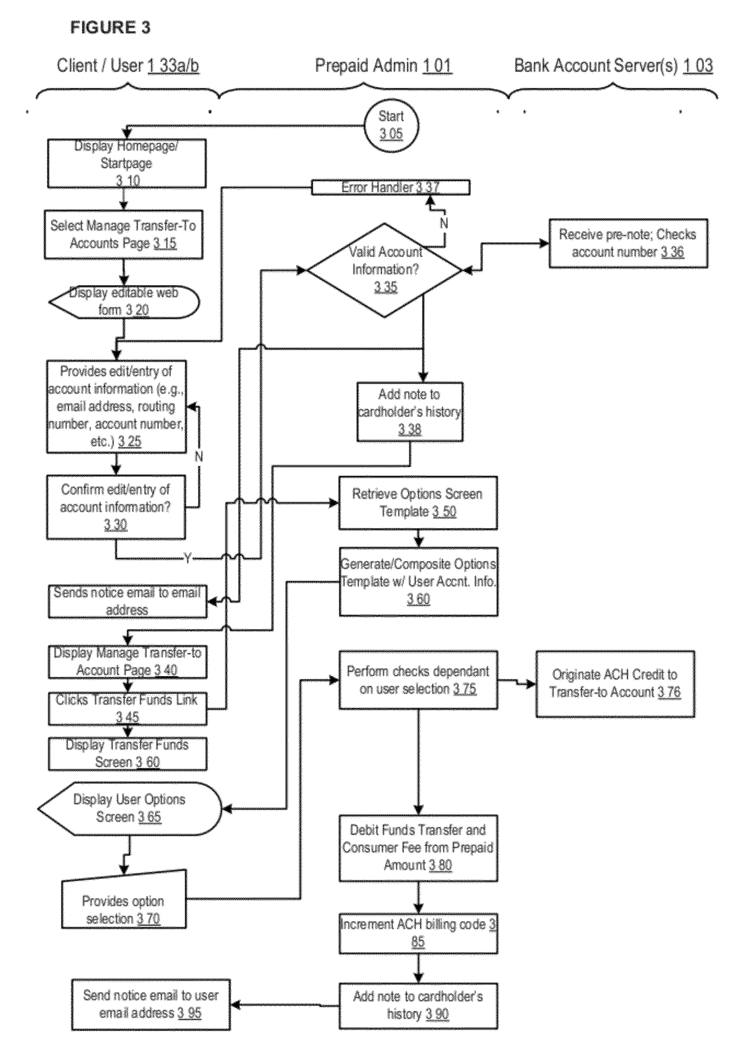

FIG. 3A is a process flow diagram illustrating scheduling a funds transfer in one embodiment of the SFT PLATFORM. As shown in FIG. 3 the SFT PLATFORM system may display a homepage 310 or start page 310 to a user 533. The user may select to manage and/or edit a Transfer-to account 315. The SFT system may display an editable web form to allow the user 533 to provide edits and/or entry of prepaid account information 325. The user may be queried to confirm account information. If confirmed 330, the system 101/102 may check edits, entries and account information 335. If not confirmed 330, the user may be presented again with the editable web form 320 until edited/entered information has been confirmed 330. If the validity of the account information is not confirmed the system may initiate an error handler 337 and present the user with the editable web form. If the system confirms the validity of the account information a note may be added to the cardholder's stored history 338 and the system may display a user interface 340 comprising an option to begin transferring funds. When the user selects the option to transfer funds 345 the system may retrieve an options interface template 350, generate and populate the option interface template with the confirmed and validated user account information 360. The may display the options interface to the user 365 to provide the user with options to select 370. The system may process and validate the user's selection 375 by querying corresponding servers with optioned information 376. The system may debit the funds transfer and a consumer fee from the user's prepaid account 380. Once complete, the system may increment an ACH billing code 385 stored on the system 102, add a note to the history of the cardholder 390 and send notice of transaction completion to the cardholder 395.

FIG. 4 provides a logic flow illustrating user server interactions of funds transfer to transfer-to account in pending validation status within embodiments of the SFT PLATFORM. In one embodiment, a SFT PLATFORM card program or sub-client may be configured to allow funds transfers to a transfer-to account in pending validation status (prior pre-note return or six day waiting period). In one implementation, the SFT PLATFORM may validate that the user credential, e.g., a cardholder or CSR can add another transfer-to account.

In one embodiment, upon the SFT PLATFORM (e.g., the prepaid administrative server 101) initiating a user interface 405, the user may choose an account for transfer, e.g., a checking or savings account 408. The user may then enter user credential information 410, such as their email address (if not already in profile), routing number, account number of the transfer-to account, and/or the like, confirm the email address, routing number and account number entered, and clicks “Submit.”

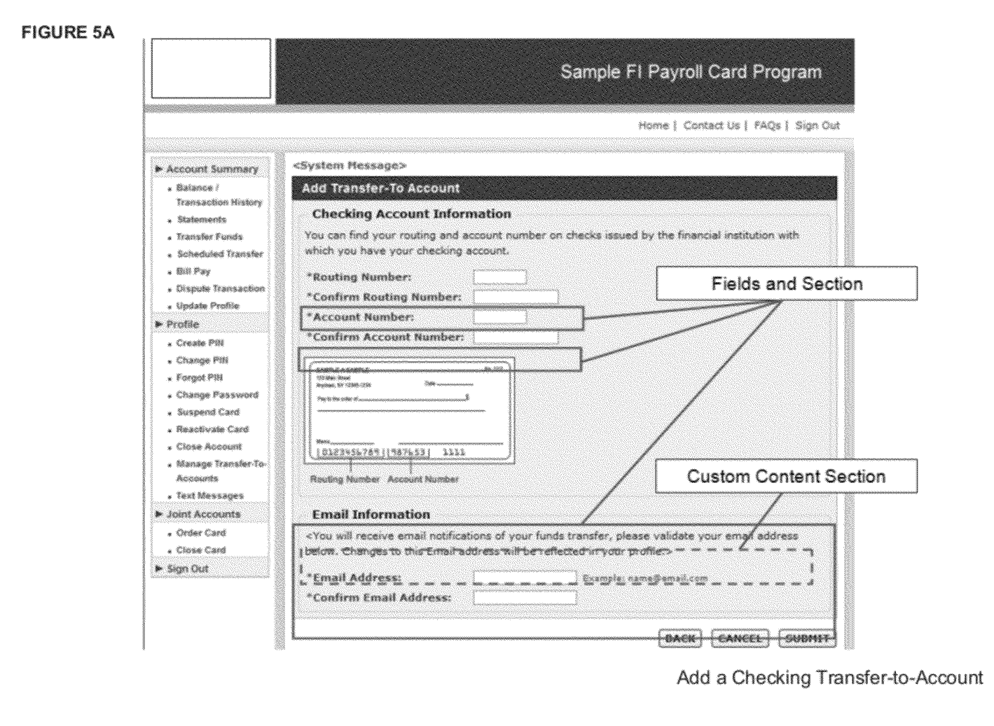

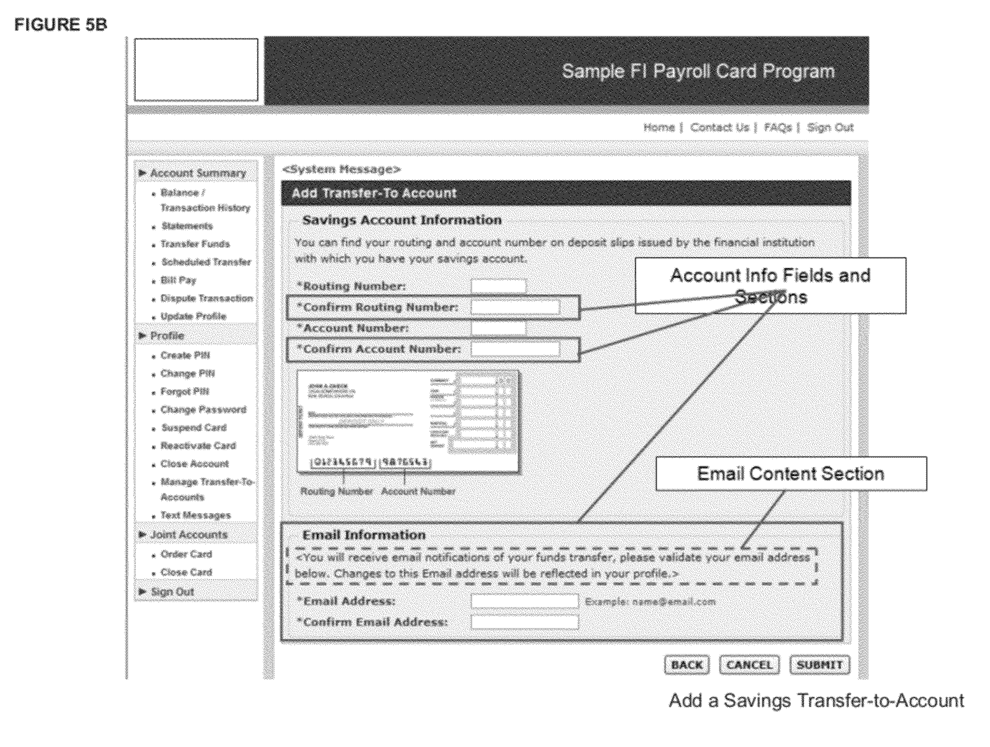

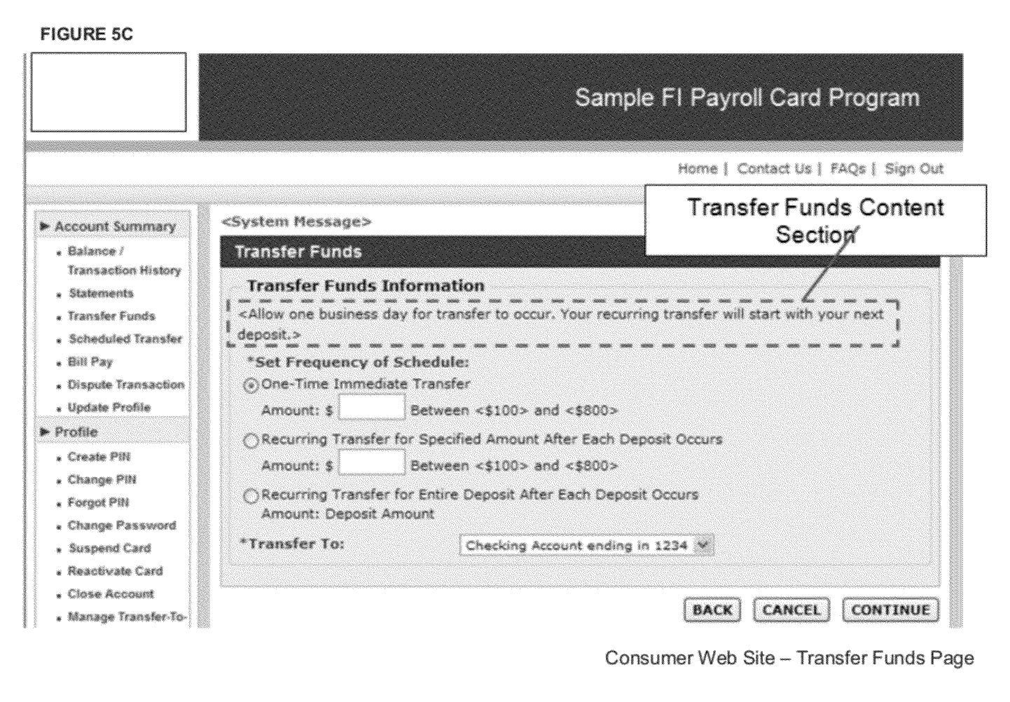

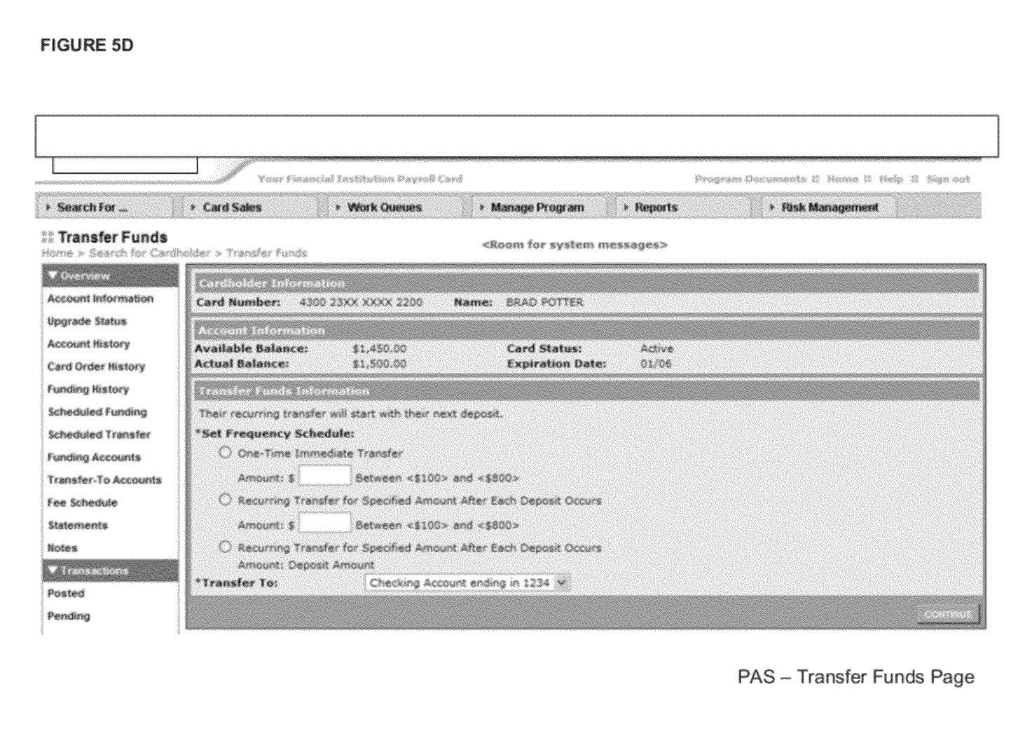

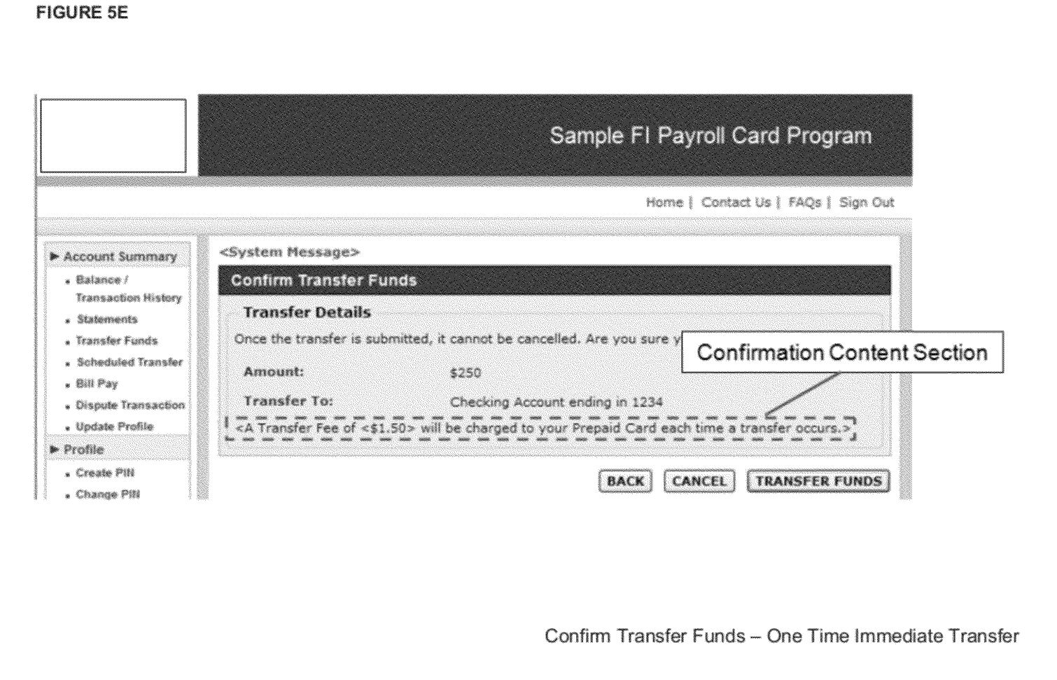

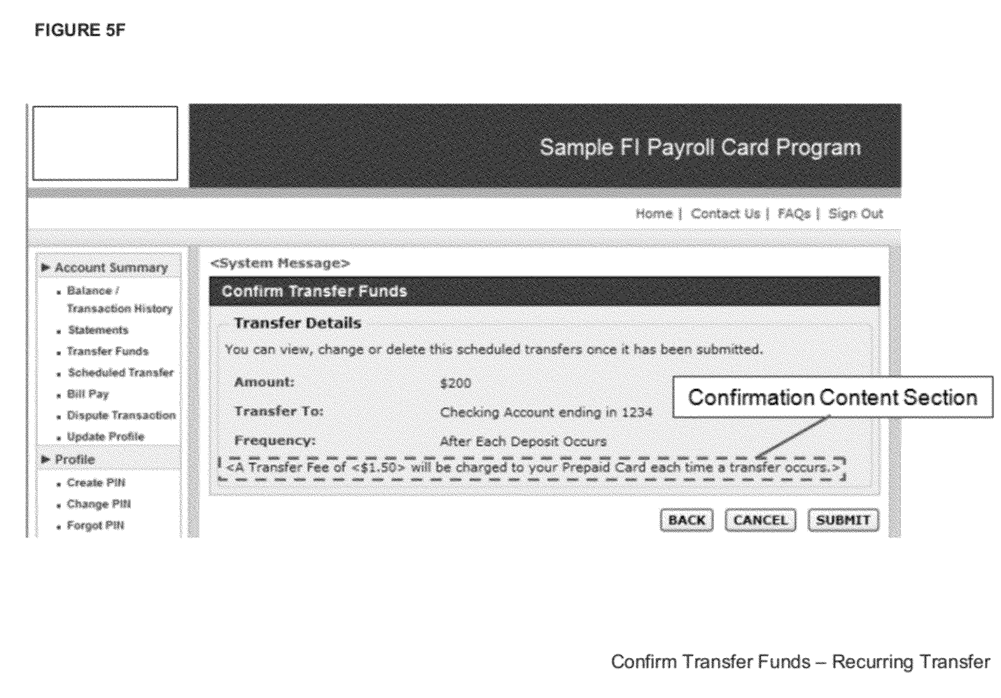

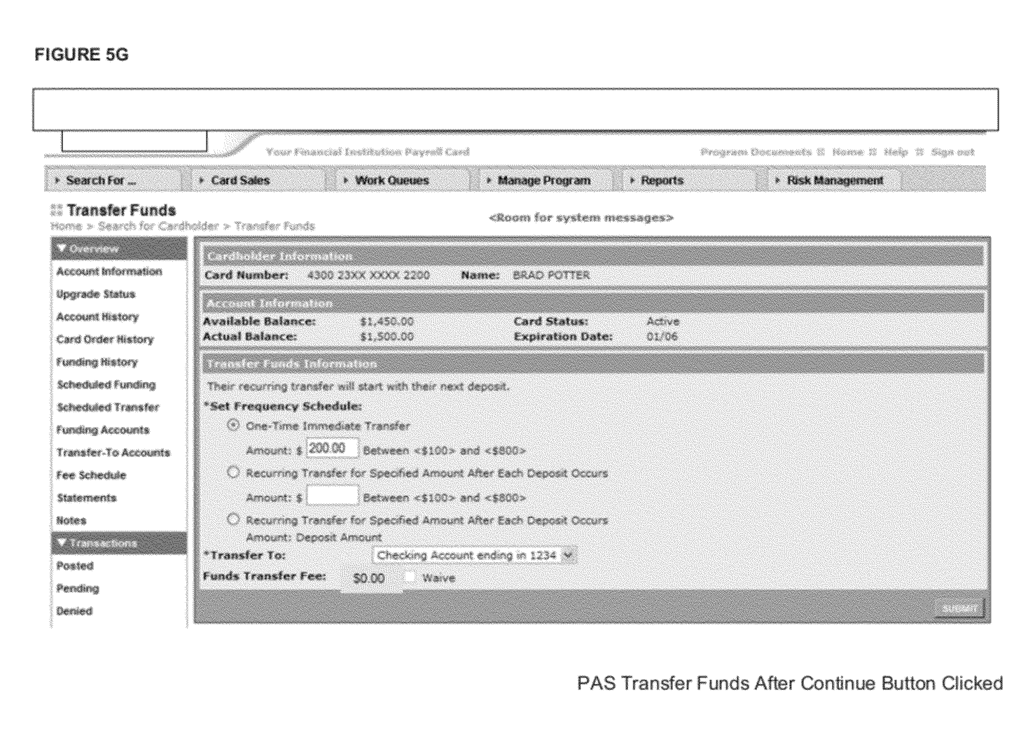

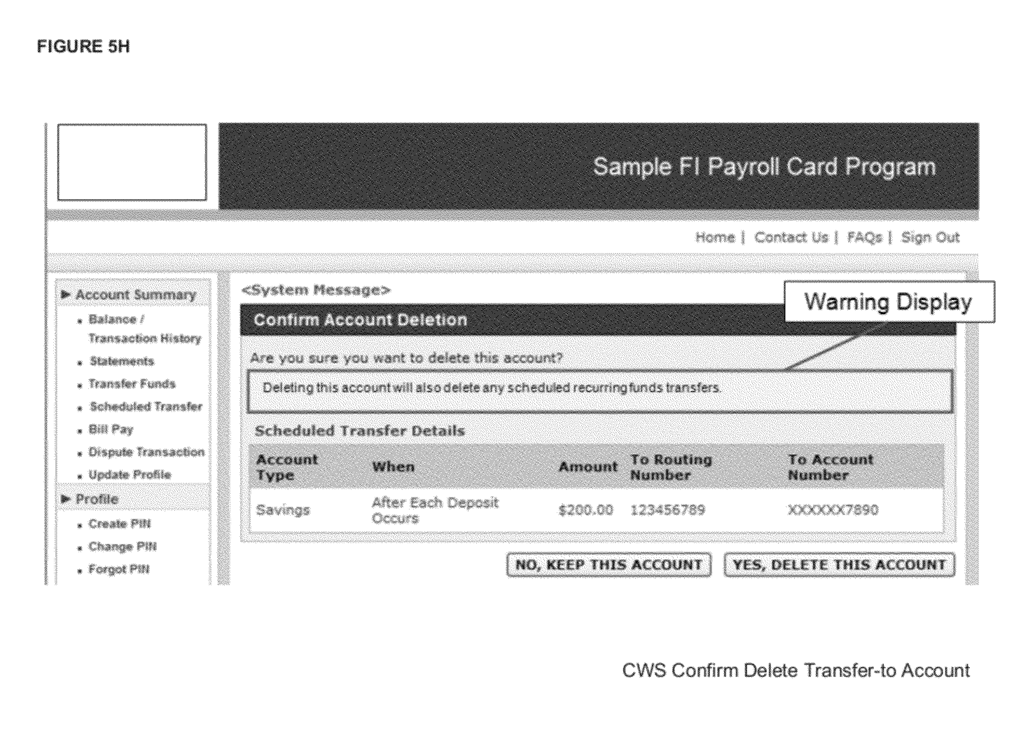

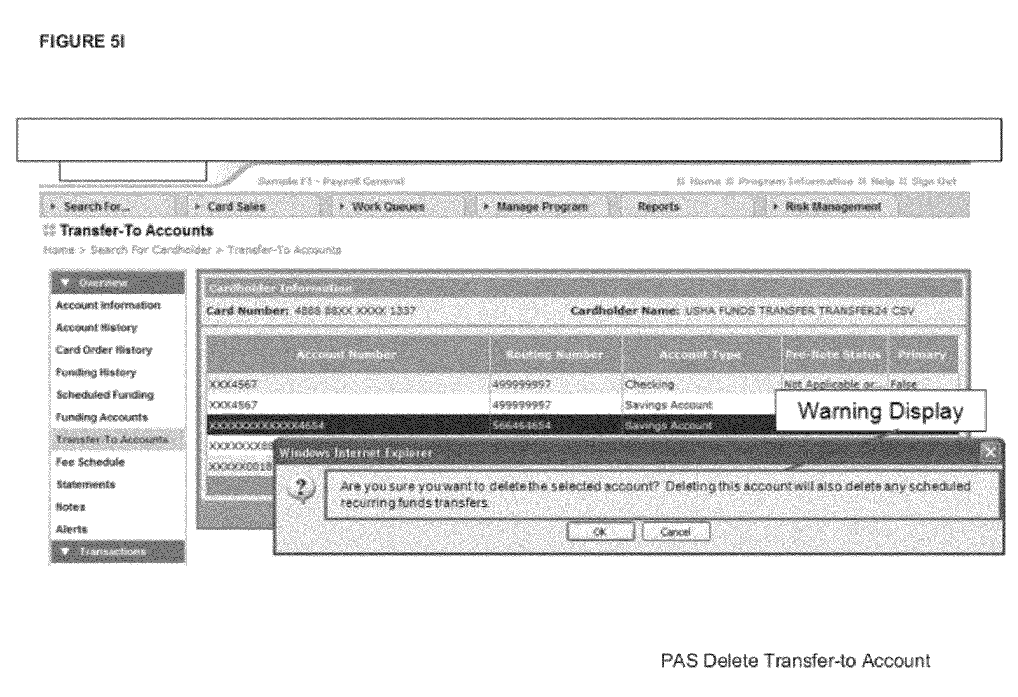

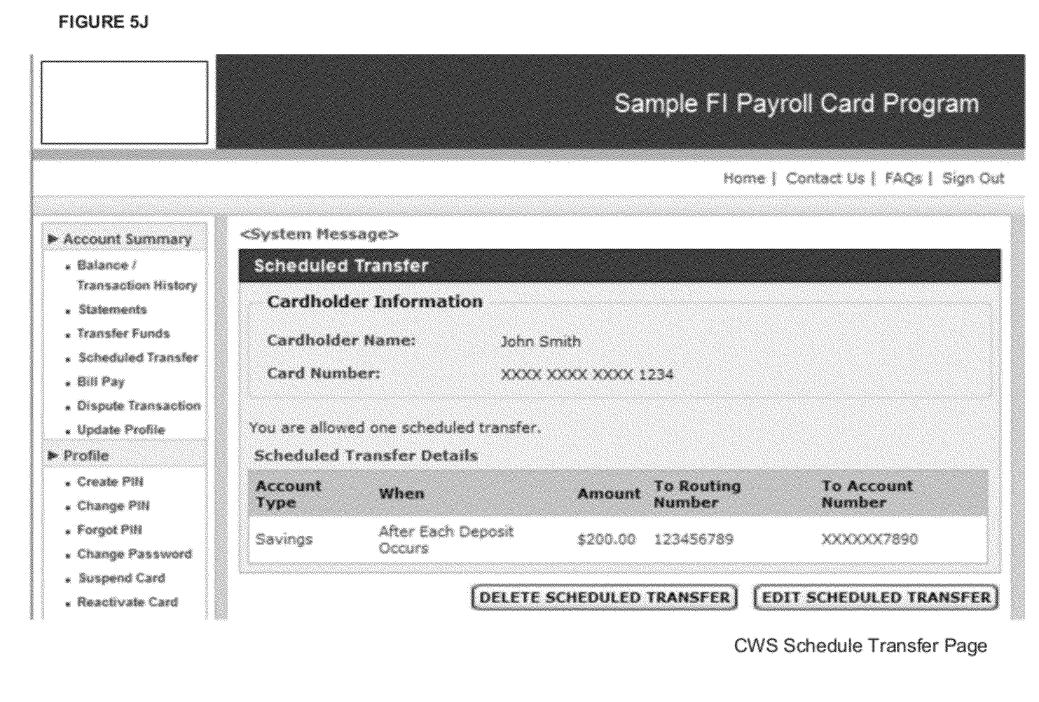

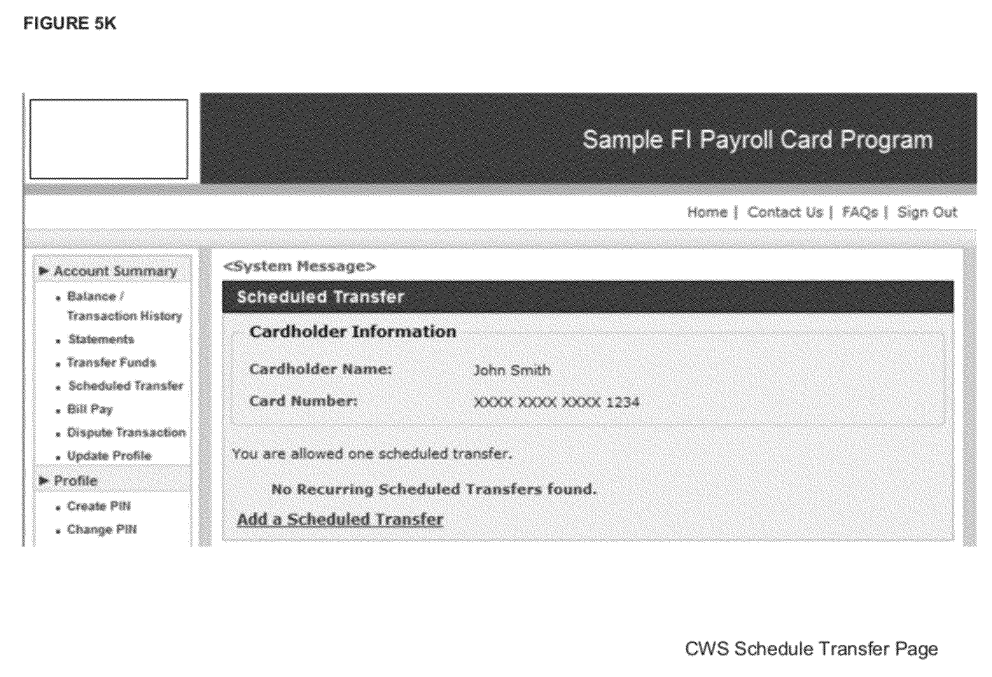

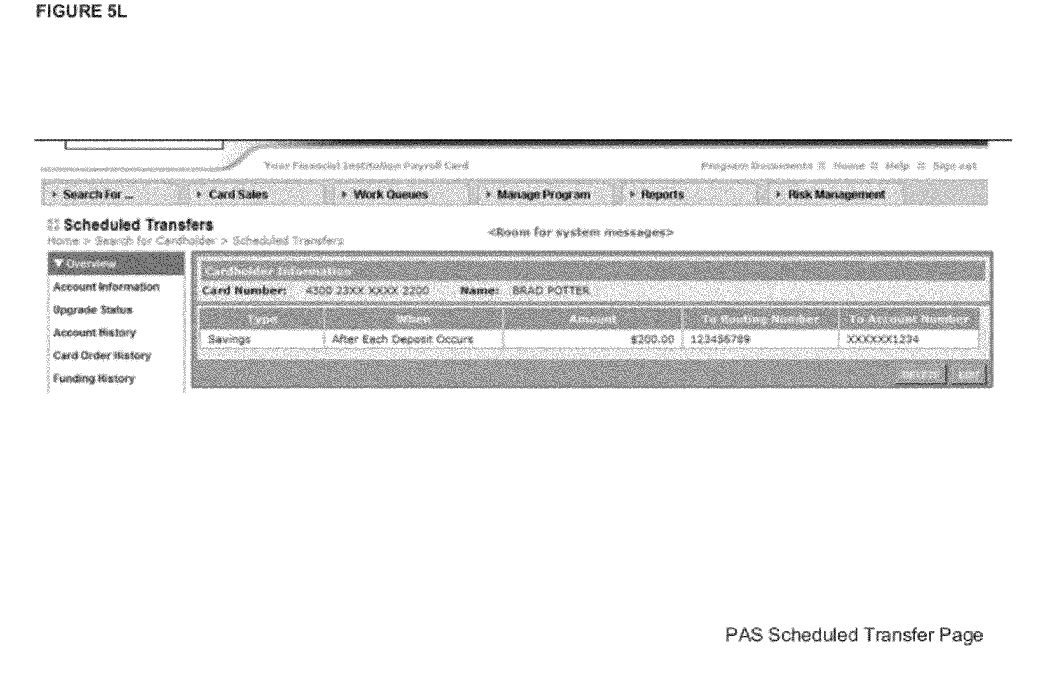

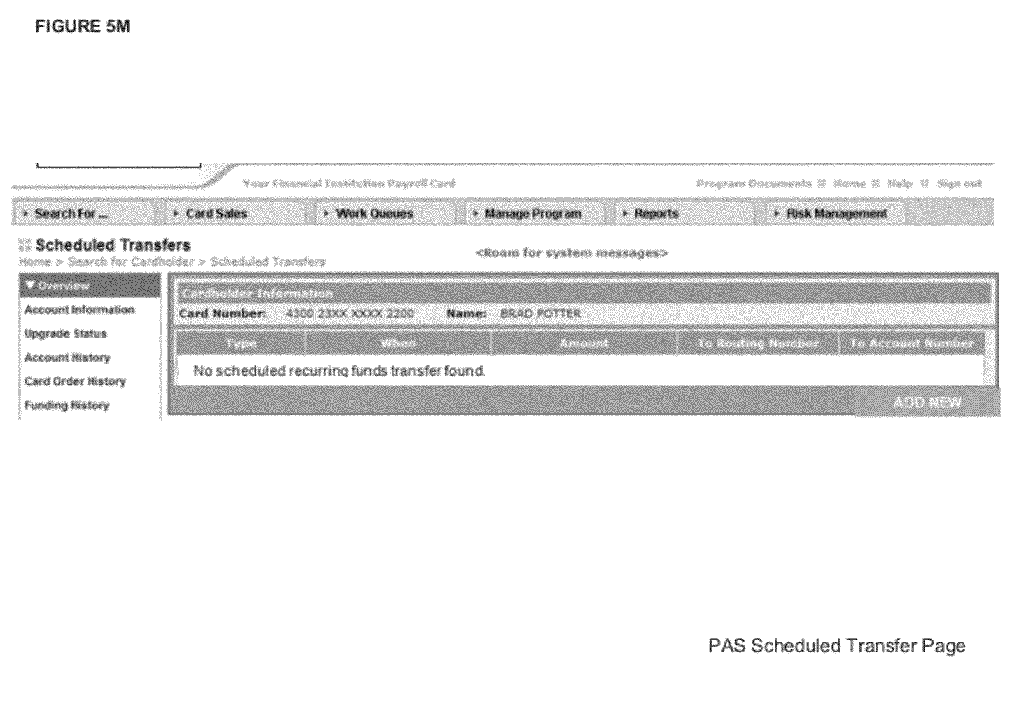

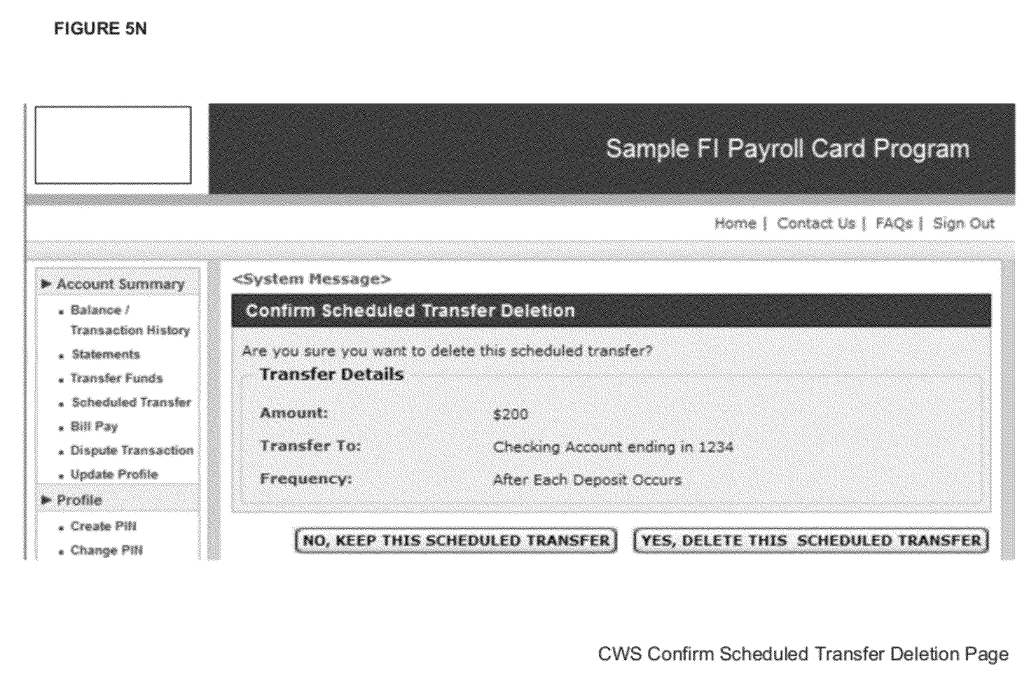

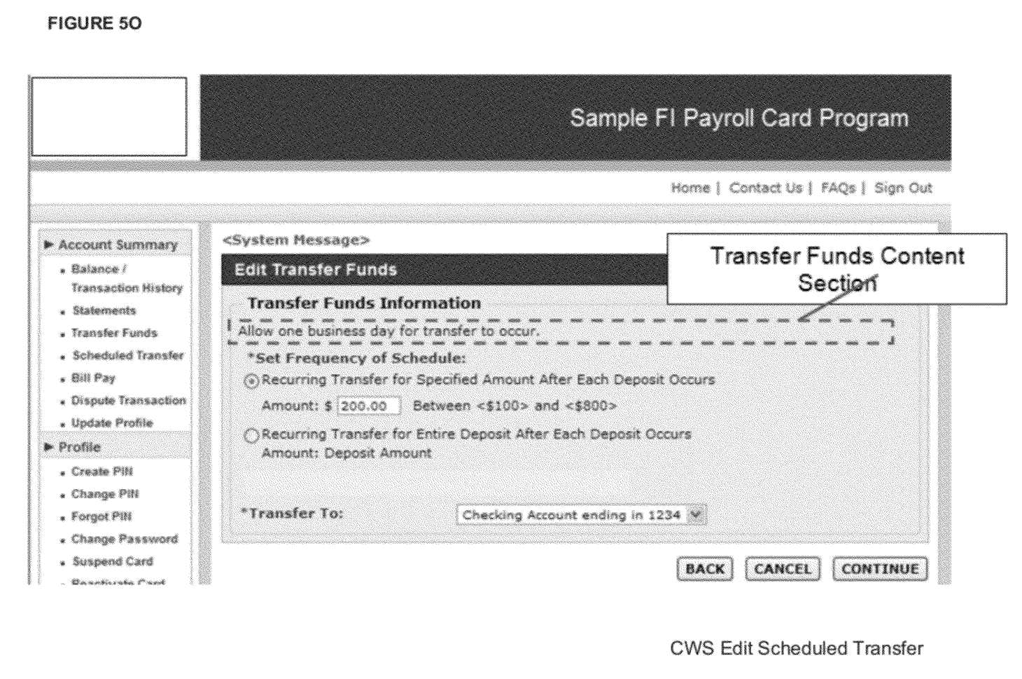

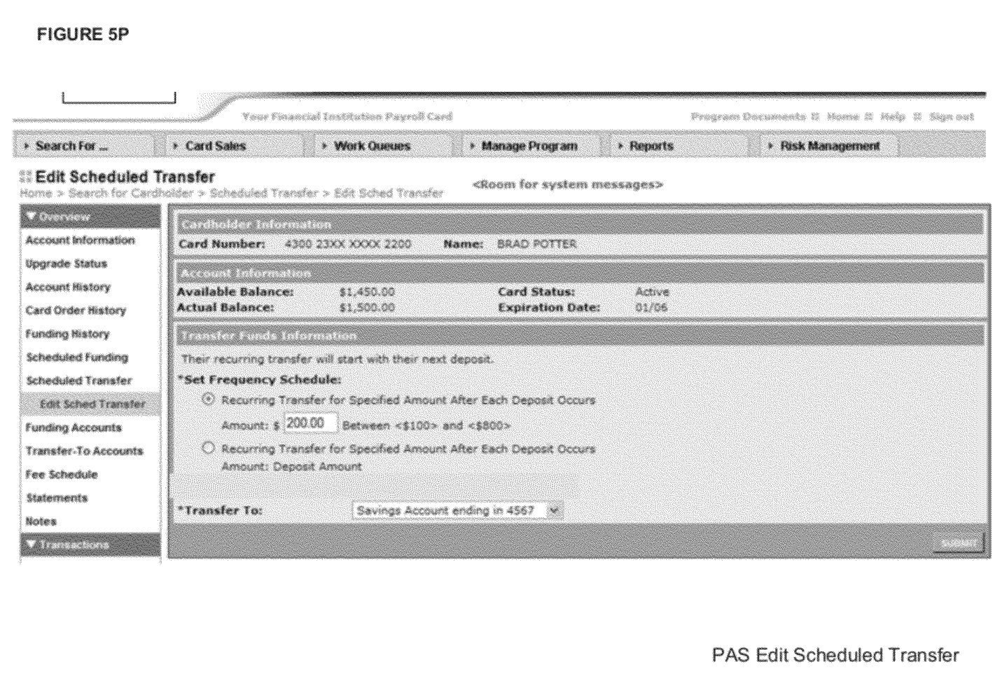

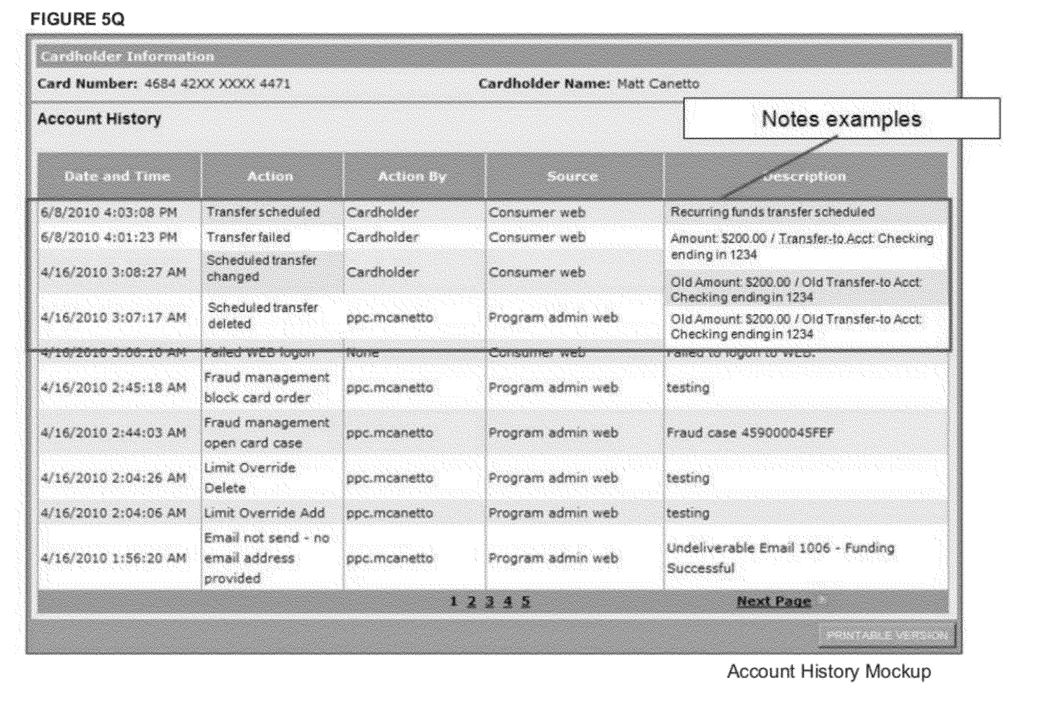

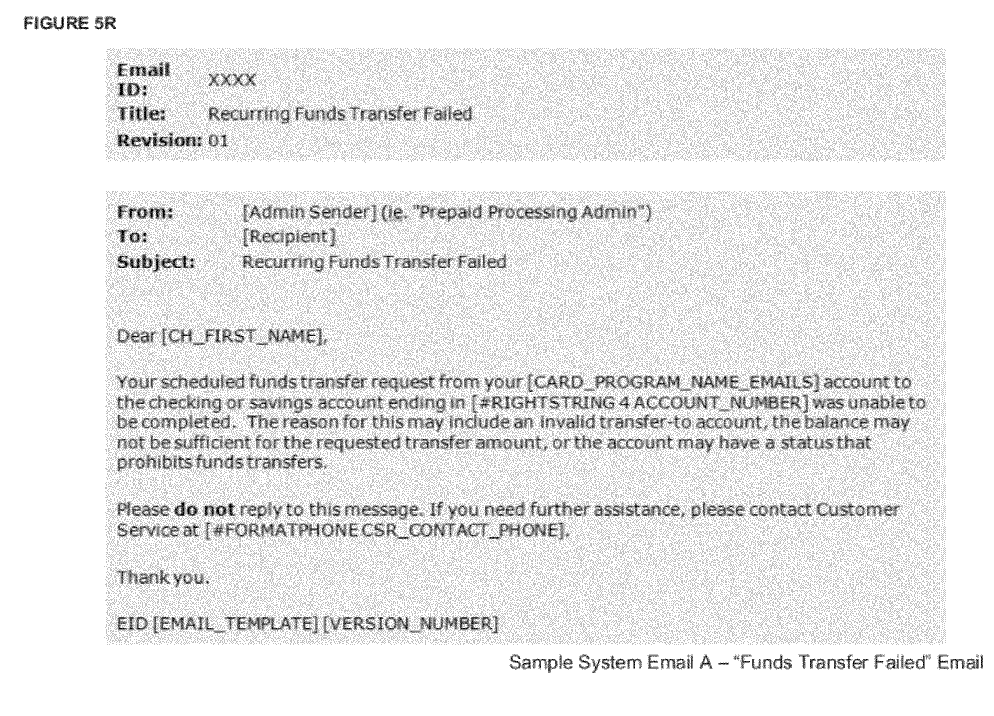

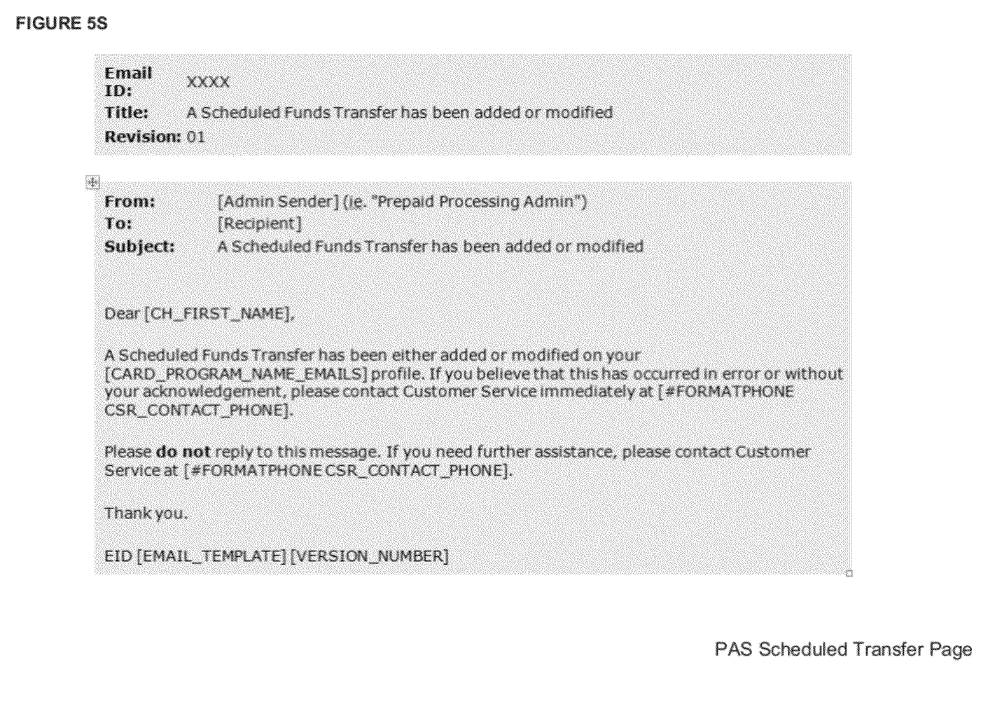

In one implementation, the account selection at 408 to create and/or request SFT PLATFORM prepaid cards may be performed via a variety of ways, e.g., by user entering information into a consumer facing web site or administrative user interface (e.g., as shown in FIGS. 5A-5S), by batch files submitted to DPS, and/or the like. In one implementation, the DPS batch files may be either system-generated or manually uploaded through the admin user interface. In another implementation, the DPS batch files may be include in external web service messages sent between transferor's/transferee's banks (e.g., 155a/b) and the SFT PLATOFRM 120, e.g., an XML message.

Once cards are created, activated and registered, the user may add a transfer-to account (e.g., a transferee's account) through the consumer facing web site or by calling a CSR and having the CSR go through a similar process on the administrative user interface. Once the transfer-to account is created, most clients use a pre-note process to validate that the cardholder owns the savings/checking account that has been added, which may be performed through ACH files and processes defined by NACHA.

In one implementation, the SFT PLATOFRM may verify the received user credential and the fund transfer request 412, e.g., the email address, routing number and account number confirmations entered. For example, the SFT PLATOFR may validate the routing number legitimacy, generate a pre-note to validate the account number, send a transfer-to account added email to the cardholder's profile email address, adds a note to the cardholder's account history, display the manage transfer-to accounts page (e.g., FIGS. 5A-5S), and/or the like.

In one implementation, if the SFT PLATFORM determines the user (e.g., the user's enrolled card program or sub-client is not configured to allow funds transfer transactions to a transfer-to account in pending validation status), the user will not be able to select transfer-to accounts in pending validation status on the transfer funds page or in the VRU with this configuration, and the SFT PLATOFRM may send an error message 416 notifying the user of the aborted fund transfer attempt.

In another implementation, the SFT PLATFORM may provide error messages when a cardholder account has no transfer-to accounts in validated or pending validation status or has the maximum number of transfer-to accounts or is in a status that does not allow funds transfer or has an open/unverifiable fraud case or is fraud blocked or is a joint cardholder. The user may not be able to select add an account from the manager transfer-to accounts page. In another implementation, when the routing number or account number or email address entered differs from the value entered in the corresponding confirm field, an error message will be returned indicating that the relevant value cannot be confirmed.

In another implementation, the error message may be displayed when the SFT PLATOFRM cannot validate the routing number, and the SFT PLATFORM does not have an email address on profile and the user does not enter one when setting up a Transfer-to account.

In a further implementation, if a recurring funds transfer has previously been scheduled, then the transfer may not occur after a deposit is received and a recurring funds transfer failed email will be sent to the cardholder's profile email address. In a further implementation, the SFT PLATFORM may determine the submitted funds transfer request exceeds a limit or funds availability, and generate an error message indicating that the funds transfer request cannot be accepted.

In a further implementation, if the SFT PLATFORM determines a previously scheduled funds transfer exceeds a limit or funds availability or the cardholder account is in invalid status or is fraud blocked or has an open/unverifiable fraud case, the SFT PLATFORM may not validate or process any recurring fund transfer request.

In one implementation, if the fund transfer request is successfully verified 415, the user may click on the transfer funds link 418 and go to the appropriate transfer funds screen or the cardholder selects to transfer funds in the VRU (e.g., FIG. 5C). The SFT PLATOFOR may then retrieve a list of available accounts for validated and pending validation status fund transfer 420, and present such options to select 420.

In one implementation, the user may configure transfer parameters (e.g., FIGS. 5C-5G) and selects to continue 423. For example, the user may configure whether the transfer is a one-time transfer or recurring transfer, the trigger of the transfer, the amount of the transfer, and/or the like. Upon receiving user configuration of the fund transfer, the SFT PLATFORM may perform various checks depending on the type of request and the user submits the request 425. For example, if the scheduled transfer is a recurring transfer, the SFT PLATFORM may verify whether the recurring period exceed a predetermined maximum number of transfers, and/or the like.

In one embodiment, the SFT PLATFORM may monitor account activities of the transfer-from account (transferor's account) and determine whether the fund transfer trigger 426 takes place based on the transfer parameters configured at 423. For example, in one implementation, if the user configure the transfer to take place when any type of load to the prepaid account (e.g., the transferor's account) occurs, such loading may trigger the transfer of funds to the selected checking or savings account at 408. In one implementation, the transferor's account may be loaded by cash/check loads through the administrative user interface, Visa's Ready Link network, Green Dot's reload network, batch files submitted to DPS either system-generated or manually uploaded through the admin UI, and external web service messages sent between systems via XML, and/or the like. In an alternative implementation, the user may set up a credit or debit card funding account to load their prepaid card for SFT PLATFORM via a consumer facing web site or administrative user interface or external web services messaging.

In one embodiment, the SFT PLATOFRM may send the fund transfer request to the bank account, which may in term originate an ACH credit to the transfer-to account per the cardholder/CSR request parameters, debit the Funds Transfer amount and consumer fee (if configured) from the prepaid account 428. Such ACH credit may be issued via the ACH network. For example, the SFT PLATFORM may generate a file in compliance with the standard NACHA format, such as but not limited to an ACH file header record format, a batch header record format, an entry detail record format, an addenda record format, a batch control record format, a file control record format, and/or the like.

For example, in one implementation, an example batch record header may comprise data elements and specifications similar to the following:

| | Field | | | |
|---|---|---|---|---|
| | Inclusion | | | |
| Data Element | Requirement | Contents | Length | Position |
| Record Type | Mandatory | ‘5’ | 1 | 01-01 |
| Service Class Code | Mandatory | 220 Credits | 3 | 02-04 |
| | | Only | | |
| Company Name | Mandatory | ABC Bank | 16 | 05-20 |
| Company | Optional | SFT2003-001 | 20 | 21-40 |
| Discretionary Data | | | | |
| Company | Required | ‘1’ + tax ID | 10 | 41-50 |
| Identification | | | | |
| Standard Entry Code | Mandatory | PPD | 3 | 51-53 |
| Company Entry | Mandatory | Payroll | 10 | 54-63 |
| Description | | | | |
| Company Descriptive | Optional | 11-11-00 | 6 | 64-69 |
| Date | | | | |
| Effective Entry Date | Required | 00-11-11 | 6 | 70-75 |
| Settlement Date | Mandatory | 000 | 3 | 76-78 |
| Originator Status | Mandatory | 1 | 1 | 79-79 |
| Code | | | | |
| Originating DFI | Mandatory | 1st 8 digits of | 8 | 80-87 |
| Identification | | tax ID | | |
| Batch Number | Required | 0000005 | 7 | 88-94 |

In the above example, the fund transfer batch file is for “Payroll” purposes as specified in the “Company Entry Description” field, and will start on “Nov. 11, 2000” as specified in the “Effective Entry Date” field.

In another implementation, the SFT PLATOFRM may generate a SFT transfer record 430. For example, the SFT PLATFORM may increment the count for the ACH records process billing code, add a note in the cardholder's account history to indicate the fund transfer transaction 431, and send a funds transfer requested email to the cardholder's profile email address 432.

In an alternative embodiment, the SFT PLATOFRM may allow a user to schedule a recurring fund transfer, in a similar manner as described in FIG. 4. For example, in one implementation, the SFT PLATOFR may check the program/sub-client configuration, presents the new transfer funds screen and shows all transfer-to accounts in validated status and pending validation status if the program/sub-client is configured to allow transfers to accounts in pending validation status. The user may select a recurring transfer option, enters a transfer amount if applicable, and submits the funds transfer request. The SFT PLATOFRM may perform various checks, schedule the funds transfers per the selected parameters, log the event in the cardholder's account history and sends the cardholder a scheduled funds added/modified email.

In one implementation, the recurring fund transfer may be triggered by a deposit to the prepaid account of the user. In one implementation, the SFT PLATFORM may perform various checks, originate an ACH credit to the transfer-to account, debits the funds transfer amount and consumer fee (if configured and applicable) from the prepaid account, increments the count for the ACH records process billing code, and sends a funds transfer requested email to the cardholder's profile email address. For example, example notification emails for the cardholder may take a form similar to those in FIGS. 5R-5S.

FIGS. 5A-5S show exemplary screen images illustrating various embodiments and implementations of the SFT PLATFORM. In one embodiment the SFT PLATFORM may be configured to provide clients with the ability to configure a card program or sub-client location to allow Funds Transfers to a Transfer-to Account in Pending validation status. A particular implementation of the SFT PLATFORM may be configured to enable Payroll, Commercial and/or GPR card program types. Depending on the implementation, such a configuration may be dependent on the card program or sub-client location being configured to allow Funds Transfer capabilities in one or more channels (e.g., as specified by existing PED settings). In some such implementations, the configuration may allow a Transfer-to Account in Pending validation status to be set as the primary Transfer-to account, and display in the Transfer-to user interface. Such a configuration may allow a user to request a Funds Transfer to a Transfer-to Account in Pending validation status in a Consumer Website (hereinafter “CWS”) and a Prepaid Administration System (hereinafter “PAS”) and, if set as the primary Transfer-to account, through a Voice Response Unit (hereinafter “VRU”). Such a configuration of the number of allowed Transfer-to Accounts may include accounts in Pending validation status when this new configuration is present.

In another embodiment the SFT PLATFORM may be configured to provide clients with the ability to enter and confirm an account email address, routing number and account number, e.g., as shown in FIG. 5A. In some embodiments, such a configuration may be implemented on CWS interfaces to add checking Transfer-to accounts and/or add savings Transfer-to accounts. A custom content section may be added and displayed if configured for a particular program or sub-client (as shown and discussed below). One implementation of the SFT PLATFORM may be configured to pre-populate a cardholder's email address (and/or other point contact) and may request the user to the confirm email address (and/or other point contact) if it exists. The text entered in the user interface fields corresponding to a cardholder's email address and user confirmation may be compared once the user has selected a user interface option to submit the information (e.g., via a “Submit” button). In such an implementation, if the text does not match exactly then an error message may be displayed (e.g., “Email address confirmation failed. Re-enter and confirm email address.”) Such a configuration may also include user interface input fields for the routing number and account number of the checking or savings Transfer-to account (as illustrated in FIGS. 5A and 5B). Such a configuration may also include an information validation protocol. Such a protocol may initiate in real-time or when the user has selected the appropriate user interface option (i.e., Submit). If the two numbers do not match exactly then an error message may be displayed (e.g., “Routing number confirmation failed. Re-enter and confirm routing number.”). If the two numbers do not match exactly then an error message may be displayed (e.g., “Account number confirmation failed. Re-enter and confirm account number.”). This process may occur prior to a pre-note account validation process.

In another embodiment, the SFT PLATFORM may be configured to allow Funds Transfers to an account in Pending validation status, and such a configuration may allow a user to select a Transfer-to Account in Pending validation status for a Funds Transfer request. In such a configuration Transfer-to Accounts in Pending validation status may be displayed in a Transfer Funds interface within CWS and PAS. In one such implementation, Transfer-to Accounts in Pending validation status may be allowed to be set as a primary Transfer-to Account. In such a an implementation, if a Transfer-to Account in Pending validation status is set as the primary funds transfer account and the cardholder attempts to transfer funds through the VRU, then the last four digits of the account number may be spoken in the VRU during the existing VRU transfer funds process. If a Transfer-to Account in Pending validation status is selected for a Funds Transfer, then the Funds Transfer may be scheduled or processed without waiting for a pre-note account validation process to change the account status to validated. If the pre-note associated with the Transfer-to Account in Pending validation status is returned, then the Transfer-to account's status may be changed to Invalid and a corresponding system email (and/or other communication) may be sent to the cardholder's profile email address (and/or other point of contact). The account may also be set as no longer available as option in the Transfer-to user interface in CWS and PAS and as an option to select in a Funds Transfer flow in the VRU.

In another embodiment, the SFT PLATFORM may be configured to provide one or more clients with the ability to configure a card program or sub-client location to allow Fund Transfers to a Transfer-to Account in Pending validation status. A particular implementation of SFT PLATFORM may be configured to enable Payroll, Commercial, and/or for General Purpose Reloadable (hereinafter “GPR”) card program types. Such a configuration may be dependent on the card program or sub-client location being configured to allow Funds Transfer capabilities in one or more channels (existing PED settings). In one embodiment, such a configuration may allow a Transfer-to Account in Pending validation status to be set as the primary Transfer-to account, and display in the Transfer To dropdown menu on the existing Transfer Funds screens and the Transfer Funds screens defined below in CWS and PAS (depending on user's security settings). This configuration may allow a user to request a Funds Transfer to a Transfer-to Account in Pending validation status in CWS and PAS and, if set as the primary Transfer-to account, through the VRU (which may be limited to one-time immediate transfer only). This configuration may remove a limitation notation or indicia (e.g., the display of “Recently added Transfer-to accounts require validation and may take up to a week before they can be used”) on the existing Transfer Funds screens in CWS. The configuration of the number of allowed Transfer-to Accounts may include accounts in Pending validation status when this configuration is present.

In another embodiment, the SFT PLATFORM may be configured to provide clients with the ability to configure a prepaid card program or sub-client location to schedule recurring Funds Transfers. A particular implementation of the SFT PLATFORM may be configured for Payroll, Commercial and/or GPR card program types. This configuration may be dependent on the card program or sub-client location being configured to allow Funds Transfer capabilities in one or more channels (e.g., as specified by existing PED settings). If a program or sub-client selects this configuration then a Transfer Funds interface may be displayed in CWS and PAS to that allow immediate one-time and recurring Funds Transfers. If a program or sub-client does not select this configuration then the existing Transfer Funds interface may be displayed in a preexisting format.

In another embodiment, the SFT PLATFORM may be configured to present a display of Transfer Funds interfaces (e.g., as illustrated by FIG. 5C) in a Prepaid Consumer Web Site (CWS) and a Prepaid Administration System (PAS) provided a card program or sub client location is configured to allow Recurring Funds Transfers. In a particular implementation of the SFT PLATFORM, if any of one or more specified conditions, such as the following conditions, are met, then the Transfer Funds link in CWS and PAS may not be displayed: (a) Prepaid account is not in Active, Closed or Issued status; (b) Card is associated with a joint cardholder; (c) Prepaid account is fraud blocked; (d) Prepaid account has an open or unverifiable fraud case; (e) Funds Transfer is not configured for the program or sub-client; (f) Card is in Delayed Activation. If the cardholder does not have one or more Transfer-to Accounts in Validated or Pending validation status (depending on program/sub-client configuration) and the cardholder selects the Transfer Funds link on the CWS, then a system message used on a pre-existing CWS Transfer Funds interface may be displayed. If the cardholder does not have one or more Transfer-to Accounts in Validated or Pending validation status (depending on program/sub-client configuration) and the CSR selects the Transfer Funds link in PAS, then a Transfer Funds interface may be displayed with an empty Transfer-to dropdown menu. If the CSR proceeds (e.g., selects the CONTINUE button) in this implementation, then an error message may be displayed (e.g., stating “Missing required field Transfer To Account”).

In some embodiments, if Funds Transfer is allowed, then a Transfer Funds user interface in the CWS may populated and displayed with various options and information related to a Funds Transfer. An example of such a user interface may comprise the following elements (as illustrated in FIG. 5C):

(a) “Transfer Funds” heading and “Transfer Funds Information” section may be displayed.

(b) A custom content section.

(c) “Set Frequency of Schedule Options” text may be displayed.

(d) “One-Time Immediate Transfer” radio button with “Amount $,” Amount field, “Between,” and minimum and maximum Funds Transfer amounts may be displayed. If the cardholder's available balance is less than the maximum Funds Transfer limit then the available balance amount may be displayed instead of the maximum limit amount.

(e) “Recurring Transfer for Specified Amount after Each Deposit Occurs” radio button with “Amount $,” Amount field, “Between,” and minimum and maximum Funds Transfer amounts may be displayed. The cardholder's available balance may not be compared to the maximum limit for this option.

(f) “Recurring Transfer for Entire Deposit after Each Deposit Occurs” radio button with “Amount $: Deposit Amount” may be displayed.

(g) “Transfer To” with a dropdown menu of available Transfer-to Accounts may be displayed.

(h) BACK, CANCEL and CONTINUE buttons may be displayed. If the BACK button is clicked then the previous interface may be displayed. If the CANCEL button is clicked then the Account Summary interface may be displayed with a standard action cancelled system message.

If Funds Transfer is allowed, then the Transfer Funds interface in the PAS may be displayed with the following elements (as illustrated in FIG. 5D):

(a) “Cardholder Information” with Card Number and Name labels and data may be displayed.

(b) “Account Information” with Available Balance, Actual Balance, Card Status and Expiration Date labels and data may be displayed.

(c) “Transfer Funds Information—Any recurring transfer will start after the next deposit to the card—“Set Frequency of Schedule Options” text may be displayed.

(d) “One-Time Immediate Transfer” radio button followed by “Amount $,” Amount field, “Between” and minimum and maximum Funds Transfer amounts may be displayed. If the cardholder's available balance is less then the maximum Funds Transfer limit then the available balance amount may be displayed instead of the maximum limit amount.

(e) “Recurring Transfer for Specified Amount after Each Deposit Occurs” radio button with “Amount $,” Amount field, “Between” and minimum and maximum Funds Transfer amounts may be displayed. The cardholder's available balance may not be compared to the maximum limit for this option.

(f) “Recurring Transfer for Entire Deposit after Each Deposit Occurs” radio button with “Amount $: Deposit Amount” may be displayed.

(h) “Transfer To” with a dropdown menu of available Transfer-to Accounts may be displayed.

(i) CONTINUE button may be displayed.

In some embodiments, interfaces and interface elements, such as CWS interfaces, text and field labels, may be translated into one or more languages, such as Spanish, and incorporated into language-specific versions (e.g., a Spanish version of CWS). In some embodiments, a client may be responsible for providing translated text for any custom content.

In another embodiment, the SFT PLATFORM may be configured to enable users with the ability to submit a one-time immediate or recurring funds transfer request from the Transfer Funds interface. Depending on the implementation, this may include options for selecting a specific amount or the amount of a deposit. In a particular implementation of the SFT PLATFORM, the selectable user interface may be utilized (e.g., a “CONTINUE button” may be clicked) on the Transfer Funds interface in CWS (as shown in FIG. 5C) or PAS (as shown in FIG. 5D), then the user may be able to submit the Funds Transfer request. If the user selects a One-Time Immediate Transfer option, a prescribed Funds Transfer process may be followed including applicable edit checks. If the user selects a Recurring Transfer option and an active Recurring Funds Transfer request already exists, then an error message may be displayed (e.g., “You are only allowed one recurring transfer. Select Scheduled Transfer to view, edit or delete your currently scheduled transfer”). If the user selects a Recurring Transfer option and enters an Amount below the minimum Funds Transfer limit amount, then a similar, appropriate error message may be displayed. If the user selects the Recurring Transfer for Specified Amount after Each Deposit Occurs option and enters an amount that exceeds maximum Funds Transfer limit amount, then an error message (e.g., the message used in a preexisting Transfer Funds interface) may be displayed. If a CSR selects the One Time Immediate Transfer option and selects the CONTINUE button on the Transfer Funds interface in PAS (FIG. 5D), then a Transfer Fee label and calculated Automated Clearing House (hereinafter “ACH”) Funds Transfer Fee amount may be displayed with a Waive fee check box and/or similarly appropriate interface. If a CSR selects a recurring funds transfer option and selects the CONTINUE button on the Transfer Funds interface in PAS (e.g., FIG. 5D), then the ACH Funds Transfer Fee may not be displayed and the fee amount may be displayed as $0.00 without the waive fee check box. If a cardholder selects the CONTINUE button from the Transfer Funds interface in CWS (FIG. 5C), a Confirm Transfer Funds interface may be populated and displayed with transfer funds options and/or information. An example of such an interface may be comprise the following elements:

(a) “Confirm Transfer Funds” header and “Transfer Details” section may be displayed.

(b) A message may be displayed based on the user's frequency selection:

If One-Time Immediate Transfer is selected, then “Once the transfer is submitted, it cannot be cancelled. Are you sure you want to transfer funds?” may be displayed.

If a Recurring Transfer option is selected, then “Once the transfer is submitted, it can be edited or deleted from the Scheduled Transfers page” may be displayed.

(c) “Amount” with the specific amount entered or “Deposit Amount” depending on which option is selected on by the CSR.

(d) “Transfer To” with the account type (Checking account or Savings account) followed by “ending in” and the last four digits of the Transfer-to Account selected on the by the CSR may be displayed.

If a Recurring Transfer option is selected, then “Frequency: After Each Deposit Occurs” may be displayed.

(g) If One-Time Immediate Transfer is selected and if the program or sub-client has an ACH Funds Transfer Fee configured, then a user interface comprised of a corresponding message may be displayed (i.e. “A Transfer Fee of <Fee Amount> will be charged to your Prepaid Card each time a transfer occurs”). If the ACH Funds Transfer Fee is not set or set at zero then a corresponding message may be displayed to notify the user (i.e. “There is no charge for this funds transfer”). Fee text and amount may not be displayed if a recurring option is selected.

(h) A custom content section may be added and displayed if configured for the program or sub-client.

(i) BACK, CANCEL and Transfer Funds buttons may be displayed in CWS.

(j) Submit button may be displayed in PAS.

(k) If the BACK button is selected then the previous interface may be displayed.

If the CANCEL button (and/or like interface) is selected, then the Transfer Funds interface may be displayed with a standard action cancelled system message.

As discussed above, some implementations may support multiple languages. For example, in one embodiment, all CWS interfaces, text and field labels may be translated into Spanish and incorporated into a Spanish version of CWS. In such an embodiment, the client may be responsible for providing translated text for any custom content.

In another embodiment, the SFT PLATFORM may be configured to provide a DPS with the ability to process recurring funds transfers. In a particular implementation of the SFT PLATFORM, a user submits a funds transfer request from the Confirm Funds Transfer interface in CWS (FIG. 5C) or the Transfer Funds interface in PAS (FIG. 5D), then the funds transfer may be processed or scheduled. If an user interface option demonstrative of One Time Immediate Transfer is selected, the existing Funds Transfer process may be followed including but not limited to all applicable edit checks, ACH credit origination to the Transfer-to account, debit of the transfer amount and fee if applicable to the prepaid account, NS delivery of funds transfer requested email (and/or other communication) to the cardholder's profile email address (and/or other point of contact). If a Recurring Transfer option is selected then a recurring funds transfer may be scheduled to occur after the next deposit to the prepaid account. If a Recurring Transfer option is selected, then the Scheduled Funds Transfer Added/Modified email (e.g., as illustrated in FIG. 5Q), and/or other communication, may be sent to the cardholder's profile email address (if it exists and/or is available). If a Recurring Transfer option is selected, then the cardholder's Account History may be updated with the following information:

(a) “Transfer scheduled” may be displayed in the Action column.

(b) “Recurring funds transfer scheduled” may be displayed in the Description column.

In the CWS, of the same embodiment, an Account Summary interface may be displayed with a Funds Transfer confirmation system message. In PAS, an Account Information interface may be displayed with a Funds Transfer confirmation system message.

In another example implementation, if a prepaid account has successfully scheduled a recurring funds transfer and receives a deposit then the Funds Transfer may be processed. In this specific example (which is intended to be illustrative and not restrictive), if any of the following conditions are met then the Funds Transfer may not be processed:

(a) The program or sub-client is not configured to allow recurring funds transfer.

(b) The Funds Transfer Amount exceeds any maximum Funds Transfer amount or count limits.

(c) The Funds Transfer Amount is below the minimum Funds Transfer amount limit.

(d) If the requested transfer amount is “Deposit Amount” and the available balance after applying the deposit is zero or negative.

(e) If the requested amount is a specified amount and the available balance is less than the specified amount.

(f) The Transfer-to Account is in an Invalid status or has been deleted.

(g) Prepaid account is not in an Active, Closed or Issued status.

(h) Prepaid account is fraud blocked.

(i) Prepaid account has an open or unverifiable fraud case.

(j) Card is in Delayed Activation.

In the same specific example (intended to be illustrative, not restrictive) if the funds transfer is not processed, a system email (e.g., as illustrated in FIG. 5G), and/or other communication, may be sent to the cardholder's profile email address (if it exists), and/or other point of contact. If the funds transfer is not processed due to a prescribed condition then the cardholder's Account History (e.g., as illustrated in FIG. 5Q) may be updated with the following information:

(a) Text notifying the user of the failed transfer (i.e. “Transfer failed”) may be displayed.

(b) Amount and last 4 digits of the transfer-to account associated with the failed scheduled transfer may be displayed.

If the funds transfer is processed, then an ACH credit for the requested amount may be originated to the selected Transfer-to Account from the prepaid account after the deposit has been applied to balance of the prepaid account. If the requested transfer amount is a “Deposit Amount” and the available balance after applying the deposit is less than the deposit amount but greater than zero then the funds transfer may be processed for the amount of the available balance. If the funds transfer is processed, the prepaid account may be debited for the amount of the Funds Transfer and the transaction may be displayed PAS and CWS. If the funds transfer is processed, the count for an associated ACH records process billing code may be incremented the same as one-time immediate funds transfers are counted. If the funds transfer is processed, a system notice (e.g., a “Funds Transfer Requested” email) may be sent to the cardholder's profile email address (and/or a like communication may be issued).

In another embodiment the SFT PLATFORM may be configured to delete a recurring funds transfer request when an associated Transfer-to Account (Checking or Savings) is deleted. In a particular implementation of the SFT PLATFORM a cardholder selects within the CWS a Transfer-to Account that is associated with an existing scheduled recurring funds transfer request, this embodiment may be configured to then display a warning user interface (e.g., FIG. 5H), wherein the text comprising said warning explains or describes the potential deletion of existing recurring funds transfers (i.e., “Deleting this account will also delete any scheduled recurring funds transfers”). The warning user interface may be may displayed in confirmation deletion page (e.g., FIG. 5H). In PAS, if a CSR selects a Transfer-to Account that is associated with an existing scheduled recurring funds transfer request, then this embodiment may be configured to then display a warning user interface (e.g., FIG. 5I), wherein the text comprising said warning explains or describes the potential deletion of existing recurring funds transfers (i.e., “Deleting this account will also delete any scheduled recurring funds transfers”). The warning user interface may be displayed on the Accounts transfer interface (e.g., FIG. 5I). As discussed above, multiple language formats may be supported.

In another embodiment, the SFT PLATFORM is configured to display Scheduled Transfer interfaces in CWS and PAS if a card program or sub-client has been configured to allow recurring funds transfer. More particularly, if the cardholder has an existing recurring funds transfer scheduled the Scheduled Funds Transfer interface in PAS and CWS may display a user interface comprising detailed information associated with the Scheduled Transfer. An example of a user interface as described in this embodiment may display the following (as further illustrated in FIGS. 5J-5M):

(a) “Scheduled Transfer” header may be displayed

(b) “Cardholder Information” section with Cardholder Name and Card Number labels and data may be displayed in CWS.

(c) “You are allowed one scheduled transfer” may be displayed.

(d) “Scheduled Transfer Details” with Account Type (Checking or Savings), When (frequency of schedule selected—“After Each Deposit Occurs”), Amount (specified amount or “Deposit Amount”), To Routing Number, To Account Number labels and data may be displayed.

(e) Delete Scheduled Transfer and Edit Scheduled Transfer buttons may be displayed.

If the cardholder does not have a recurring funds transfer already scheduled then the Scheduled Transfer interface may display some variation of explanatory text and/or notification (e.g. “No recurring scheduled transfer found”) with a selectable user interface field (e.g. “Add a Scheduled Transfer” button) (e.g., FIG. 5K) that is linked to the previously described Transfer Funds interfaces (FIGS. 4C and 5D).

Another embodiment the SFT PLATFORM may be configured to provide a user with the ability to delete a recurring funds transfer. A particular implementation of the SFT PLATFORM may be configured to delete the Recurring Scheduled Transfer request if a selectable user interface on the Scheduled Transfer interface (i.e., “Delete Scheduled Transfer” button) (e.g., FIG. 5J) has been selected, and wherein the selectable user interface is linked to a deletion protocol of the Scheduled Transfer. In PAS, a warning user interface may be displayed, wherein the text comprising said warning notifies the user of the potential deletion of the scheduled fund transfer and may request user confirmation (i.e., “Are you sure you want to delete the scheduled funds transfer?”). The warning user interface may also include an affirmative and negative user response interface (e.g., “OK” and/or “CANCEL” buttons and/or the like). In CWS or PAS, a Confirm Scheduled Transfer Deletion interface may be displayed with the following information (as illustrated in FIG. 5M):

(a) “Confirm Scheduled Transfer Deletion header with “Are you sure you want to delete the scheduled funds transfer?” text may be displayed.

(b) Transfer Details section with the Amount, Transfer to account and Frequency of the recurring transfer labels and data may be displayed for the recurring scheduled transfer request that is being confirmed for deletion.

(c) No, Keep this Scheduled Transfer and Yes, Delete this Scheduled Transfer buttons may be displayed.

If the affirmative user response interface in PAS or in CWS (i.e. “OK” button, “Yes, Delete this Scheduled Transfer” button, etc.) is selected, then the following items may occur:

(a) The selected recurring transfer request may be deleted.

(b) The Account Summary interface in CWS or the Account Information interface in PAS may be displayed.

(c) The cardholder's Account History (e.g., FIG. 5Q) may be updated with a notification of the deleted transfer (i.e., “Scheduled transfer deleted”), the Amount and last 4 digits of the Transfer-to account associated with the deleted scheduled transfer.

As discussed above, multiple languages may be supported. For example, in one embodiment, all CWS interfaces, text and field labels may be translated into Spanish and incorporated into a Spanish version of CWS. The client may be responsible for providing translated text for any custom content.

In another embodiment the SFT PLATFORM may be configured to give a user the ability to edit a recurring funds transfer. A particular implementation of the SFT PLATFORM may be configured to display a Edit Scheduled Transfer interface in the PAS (e.g., FIG. 5P) and CWS (e.g., FIG. 5O) if a selectable user interface on the Edit Scheduled Transfer interface (e.g., an “Edit Scheduled Transfer” button) has been selected, and where in the selectable user interface is linked to a protocol for the modification or edit of a scheduled transfer. In CWS, a Edit Scheduled Transfer interface may be displayed with the following edit protocol information (as illustrated in FIG. 5O):

(a) “Edit Scheduled Transfer Funds” header may be displayed.

(b) “Transfer Funds Information” section may be displayed.

(c) A custom content section may be added and displayed.

(d) “Set Frequency of Schedule” may be displayed.

(e) Recurring Transfer for Specified Amount after Each Deposit Occurs radio button option with Amount field and “Between” text followed by the program/sub-client configured minimum and maximum Funds Transfer limit amounts may be displayed.

(f) Recurring Transfer for Deposit Amount after Each Deposit Occurs radio button option with “Deposit Amount” may be displayed.

(g) “Transfer To” with a dropdown menu of available Transfer-to Accounts may be displayed.

(h) BACK, CANCEL and CONTINUE buttons may be displayed in CWS.

(i) The Frequency of Schedule radio button of the existing recurring funds transfer may be defaulted.

(j) The Amount of the existing recurring funds transfer may be pre-populated if applicable.

(k) The Transfer-to Account dropdown selection of the existing recurring funds transfer may be defaulted.

(l) If the BACK button is clicked then the previous interface may be displayed.

(m) If the CANCEL button is clicked then the Account Summary interface may be displayed with a standard action cancelled system message.

In PAS, a Edit Scheduled Transfer interface may be displayed with the following edit protocol information (for example, as illustrated in FIG. 5P):

(a) “Edit Scheduled Transfer Funds” header may be displayed.

(b) “Cardholder Information” with Card Number and Name labels and data may be displayed.

(c) “Account Information” with Available Balance, Actual Balance, Card Status and Expiration Date labels and data may be displayed.

(d) “Transfer Funds Information—Any recurring transfer will start after the next deposit to the card—Set Frequency of Schedule Options” text may be displayed.

(e) Recurring Transfer for Specified Amount after Each Deposit Occurs radio button option with Amount field and “Between” text followed by the program/sub-client configured minimum and maximum Funds Transfer limit amounts may be displayed.

(f) Recurring Transfer for Deposit Amount after Each Deposit Occurs radio button option with “Deposit Amount” may be displayed.

(g) “Transfer To” with a dropdown menu of available Transfer-to Accounts may be displayed. A Submit button may be displayed.

(h) The Frequency of Schedule radio button of the existing recurring funds transfer may be defaulted.

(i) The Amount of the existing recurring funds transfer may be pre-populated if applicable.

(j) The Transfer-to Account dropdown selection of the existing recurring funds transfer may be defaulted.

If the CONTINUE button is selected then the embodiments, implementations and examples related to recurring transfer funds may be used.

In one embodiment of the SFT PLATFORM, example aspects of varying implementation details may include a configuration option to allow a Funds Transfer to a Transfer-to Account in pending validation status the to not stop an existing pre-note validation process from being initiated. In such an implementation a funds request may proceed during the pre-note validation process.

In one embodiment of the SFT PLATFORM, example aspects of varying implementation details may include a configuration option to allow a Funds Transfer to a Transfer-to Account in Pending Validation status the ability to treat a Transfer-to Account in Pending Validation status like an account in Validated status (i.e. able to set as the Primary account, spoken in VRU if it is the primary account, etc.).

In one embodiment of the SFT PLATFORM, example aspects of varying implementation details may include a display of a transfer funds link or option on the CWS which may continue to use existing logic (i.e. card status, fraud status, etc.).

In one embodiment of the SFT PLATFORM, example aspects of varying implementation details may include a one-time immediate funds transfer from a Transfer Funds interface with the ability to work exactly as it may have prior to any system modifications.

In one embodiment, the SFT PLATFORM may be configured to leverage existing elements of a system with or without introducing any new elements (i.e. limits, fees, billing codes, system emails, card statuses, Transfer-to Account statuses etc.).

In one embodiment of the of the SFT PLATFORM, example aspects of varying implementation details may include changes to a CWS that may not impact conformity to web content accessibility guidelines.

In some embodiments, the SFT PLATFORM may provide an extensible architecture, for example recurring funds transfer requests are may be added upon introduction to short-term recurring funds transfer solutions implemented for third party banks.

In one embodiment of the SFT PLATFORM, an example implementation may apply ACH Funds Transfer Fees to recurring funds transfers.

In one embodiment of the SFT PLATFORM, the PAS interface may be configured to use a system's preexisting fund transfer security capability.

In one embodiment, the SFT PLATFORM may be configured to process, display and report ACH credits and returns that result from recurring funds transfers in the same fashion as from immediate funds transfers.

In one embodiment, the SFT PLATFORM may be configured translate all interfaces (i.e. text, buttons and other items) into Spanish and incorporated into a Spanish version of the CWS.

In another embodiment the SFT PLATFORM may be configured to enable a user access to the capabilities and options of the SFT PLATFORM entirely through a VRU.

In another embodiment, aspects of the SFT PLATFORM may be adapted to additional or alternative imbursement opportunities, programs and/or the like. More particularly, for example, the SFT PLATFORM may be applied to the municipal initiative defined to issue prepaid cards for unemployment and disability benefits.

In another embodiment, the SFT PLATFORM may be configured to change the funds transfer capability of a prepaid processing system to enable third party entities to better comport with various regulatory initiatives (i.e. State of California's Unemployment and Disability Benefits Prepaid Card Program RFP).

In another embodiment, the SFT PLATFORM may be configured to schedule a one-time funds transfer for a date in the future.

In another embodiment, the SFT PLATFORM may be configured to set-up a recurring Funds Transfer through at VRU.

In another embodiment, the SFT PLATFORM may be configured to select the full available balance as a Funds Transfer amount

In another embodiment, the SFT PLATFORM may be configured to schedule a recurring Funds Transfer periodically (i.e. every week, every two weeks, every 1^{st} or 15^{th} of the month or monthly).

In another embodiment, the SFT PLATFORM may be configured to apply a transfer fee (i.e. an ACH Funds Transfer fee) to a funds transfer initiated from a recurring funds transfer request.

In one embodiment of the SFT PLATFORM an example benefit may be the fulfilled enhancement request by 3^{rd} party banks to better comport with regulatory initiatives to issue prepaid cards for unemployment and disability benefits.

In one embodiment of the SFT PLATFORM an example benefit may be an increased revenue for a processing system from a third party bank through regulatory programs and initiatives.

In one embodiment of the SFT PLATFORM an example benefit may be an increased funds transfer facility for all clients and all cardholder using this facility.

In one embodiment of the SFT PLATFORM an example benefit may be an increased chance of long term return of a 3^{rd} party's prepaid business.

### SFT Platform Healthcare Payment

In one embodiment, the SFT PLATFORM may be applied to a healthcare prepaid payment platform, whereby medical payments may be executed by scheduled fund transfers via the SFT PLATOFRM, from insured patients after loading their prepaid cards at a healthcare provider. The scheduled fund transfers may be triggered by approval of verified procedures, e.g., an insurance carrier (acting as a third party verifier 150 in FIG. 1A) approving a scheduled medical treatment.

For example, a patient may possess a SFT PLAYFORM healthcare prepaid card, which may comprises the patient's profile information associated with the SFT PLATFORM service, such as, but not limited to patient's name, address, medical conditions, medical treatment, insurance policy, and/or the like. In one implementation, the patient may submit a verification request to the insurance provider indicating a scheduled medical treatment prior to the medical appointment. Within implementations, the patient may indicate the type of the medical treatment, identification of the healthcare provider, and/or the like, based on which the insurance provider may pre-approve a payment amount associated with the potential medical treatment for the patient. In one implementation, upon receiving medical treatment, the patient may swipe the SFT PLATFORM prepaid card at the registry (e.g., a point-of-sale terminal, etc.) at the healthcare provider, and the insurance provider may authorize an insured amount of payment to the healthcare provider.

In one embodiment, the SFT PLATFORM may facilitate electronic payment from the insurance provider to the healthcare provider. In an alternative embodiment, the SFT PLATFORM may generate a paper check for payment if electronic payment transfer is not available, or upon request of the healthcare provider.

In one implementation, the SFT PLATFORM may perform authorization, clearing and settlement of the medical claims upon receiving insured patient card information from a healthcare provider. The SFT PLATFORM cards may be issued via a commercial bank, wherein the issuing commercial bank may connect the patient's bank account with the SFT PLATFORM prepaid card.

In a further implementation, the SFT PLATFORM may allow the patient to pay the uninsured amount of the medical payment to the healthcare provider via the SFT PLATFORM prepaid card. For example, the patient may register a bank account associated with the SFT PLATFORM prepaid card, and authorize the healthcare provider to charge the uninsured amount by swiping his card at the healthcare provider. In one implementation, the SFT PLATFORM may communicate with the patient's bank and facilitate fund transfer from the patient's bank account to the healthcare provider.

In a further implementation, the SFT PLATFORM may adopt a variety of user payment vehicles, such as, but not limited to a card, a cellular phone, a smart phone, a PDA, an electronic security key, and/or the like. For example, a patient may associate his personal cellular phone with the SFT PLATFORM, and after receiving a medical treatment, he may send a prepaid request to the SFT PLATFORM by a text message, a phone call, or an email to customer service. The SFT PLATFORM may the verify the medical conditions and authorize the transaction.

FIG. 6 shows a block diagram illustrating various embodiments of the SFT PLATFORM. In one embodiment, when a patient 601 has a scheduled medical appointment, the patient may contact the insurance provider and submit a request for prepaid payment service 610. In one implementation, the patient may call, email, or send a text message of a prepaid request to the customer service of his insurance provider. In an alternative implementation, the SFT PLATFORM 602 may process the prepaid request and communicate with the insurance provider 603. Upon receiving the request, the insurance may process the prepaid request based on the insurance policy 115. In one implementation, the insurance provider may determine whether the patient and/or the scheduled medical appointment is qualified for the prepaid payment service. For example, if the patient's scheduled medical treatment is not covered by his insurance policy, the insurance provider may deny prepaid service and the patient may receive a notification of rejection 620.

In another implementation, if the patient and the scheduled medical treatment are verified by the insurance provider, the SFT PLATFORM may establish an authorized prepaid record and store it in a prepaid database. For example, an example XML code of a prepaid record may take a form similar to the following:

<RecordID>

<PatientName>

John Smith

</PatientName>
<RequestSubmissionTime>

19:45 09-09-2013

</RequestSubmissionTime >
<InsuranceProvider>
Dental ASD Provider
</InsuranceProvider>
<InsurancePlan>
Dental All Coverage
</InsurancePlan>
<RequestMatter>

<MatterID>
Dental00090909
</MatterID >
<MatterDate>
09-15-2013
</MatterDate >
<Matter>
root canal therapy
</Matter>
<MatterCoverage>
80%
</Matter>
<Provider>
ABC Dental
</Provider>
...

<InsurnedAmountMaximum>

1500.00 </InsurnedAmountMaximum>

<AllowedAmount> 1000.00 </AllowedAmount>
...

</RecordID>

As shown in the above example, the patient submitted a request for prepaid service for a dental procedure “root canal therapy” scheduled at “ABC dental” on Sep. 15, 2013, and the insurance provider authorized an up-to 1000.00 dollar medical claim settlement for the provider “ABC dental.”

In one embodiment, after receiving the medical treatment, the patient may submit prepaid service information at the healthcare provider, e.g., swipe his prepaid card 623 at a POS registry, and the healthcare provider 604 may submit medical claim information 630 to the SFT PLATFORM associated with the patient account information obtained from his prepaid card. In one implementation, the medical claim information may comprise, but not limited to a claimed amount, the date of treatment, healthcare provider's identification information, medical treatment, and/or the like.

In one embodiment, upon receiving the medical claim request, the SFT PLATFORM may retrieve the previously stored prepaid record 635, which may be similar to the above example, and compare the received patient account and medical claim information with the prepaid record 638 for verification. In one implementation, the SFT PLATFORM may verify the medical claim via a plurality of criteria. For example, the SFT PLATFORM may verify the received amount from the healthcare provider exceeds the pre-allowed amount; whether the procedure performed and/or the healthcare provider is consistent with the procedure and/or healthcare provider indicated in the prepaid record. In a further implementation, the SFT PLATFORM may verify whether the date of the medical treatment performed is within an allowed time frame. For example, if prior to treatment, the patient indicated the treatment would be performed on Sep. 15, 2013, the SFT PLATFORM may allow a flexibility of plus/minus a period of time, e.g., if the allowable time flexibility is 5 days, and the procedure is performed within Sep. 10-20, 2013, the SFT PLATFORM may recognize the medical claim as matching the previously authorized prepaid record.

In one embodiment, if one or more criteria does not match the prepaid record, e.g., the requested claim amount exceeds the allowed amount established in the prepaid record, the procedure performed is different from that indicated in the record, etc., the SFT PLATFORM may direct the payment request to further inspection 640. In one implementation, the SFT PLATFORM may communicate with the patient and/or the healthcare provider to clarify the inconsistency to allow reasonable flexibility. For example, a SFT PLATFORM representative may call, text-message and/or email the patient to inquire about the inconsistency and determine whether the received claim request is fraudulent.

In one implementation, if SFT PLATFORM determines the received medical claim matches the prepaid record, and/or is not fraudulent, the SFT PLATFORM may send an authorization notice to the insurance provider to process the medical claim 642 and the healthcare provider may receive payment 645.

In another implementation, if the SFT PLATFORM determines the received medical claim request is fraudulent, e.g., no such prepaid record exists, etc., the SFT PLATFORM may send an alert to the patient 650, and deny the payment request 655.

### SFT Platform Mobile Application

FIGS. 7A-7C show exemplar application user interface diagrams illustrating example features of a mobile app in some embodiments of the SFT PLATFORM. In some implementations, as shown in FIG. 7A, the app executing on the client device of the user may include an app interface providing various features for the user. In some implementations, the app may include an indication of the location (e.g., name of the merchant store, geographical location, information about the aisle within the merchant store, etc.) of the user, e.g., 711. The app may provide an indication of a transfer amount, a loaded amount, e.g., 712. In some implementations, the app may provide various options for the user to select for configuration of the fund transfer, e.g., to choose a transferor's account and/or a transferee's account. For example, the user may choose from a number of cards (e.g., credit cards, debit cards, prepaid cards, etc.) from various card providers, e.g., 713. In some implementations, the app may provide the user the option to transfer funds included in a bank account of the user, e.g., a checking, savings, money market, current account, etc., e.g., 714. In some implementations, the user may have set default options for which card, bank account, etc. to use for the purchase transactions via the app. In some implementations, such setting of default options may allow the user to initiate the transaction via a single click, tap, swipe, and/or other remedial user input action, e.g., 715. In some implementations, when the user utilizes such an option, the app may utilize the default settings of the user to initiate the transaction, and/or a scheduled fund transfer configuration. In some implementations, the app may allow the user to utilize other accounts (e.g., Google™ Checkout, Paypal™ account, etc.) to set up fund transfer, e.g., 716. In some implementations, the app may allow the user to utilize rewards points, airline miles, hotel points, electronic coupons, printed coupons (e.g., by capturing the printed coupons similar to the product identifier) etc., to set up a fund transfer transaction, e.g., 717-718. In some implementations, the app may provide an option to submit the fund transfer schedule request when the fund transfer parameters has been configured, e.g., 719 (further aspects of the authorization is discussed at 415 in FIG. 4). In some implementations, the app may provide a progress indicator provide indication on the progress of the transaction after the user has selected an option to submit transfer configuration, e.g., 720. In some implementations, the app may provide the user with historical information on the user's prior fund transfers via the app, e.g., 721. In some implementations, the app may provide the user with an option to share information about the transaction (e.g., via email, SMS, wall posting on Facebook®, tweet on Twitter™, etc.) with other users, e.g., 722. For example, the user may want to share information about a donation to a charity fund raising program.

In some implementations the app may provide the user an option to display the product identification information captured by the client device (e.g., in order to show a customer service representative at the exit of a store the product information), e.g., 724. In some implementations, the user, app, client device and or SFT PLATFORM may encounter an error in the processing, e.g., when the fund transfer request is denied at 415 in FIG. 4. In such scenarios, the user may be able to chat with a customer service representative (e.g., VerifyChat 723) to resolve the difficulties in the purchase transaction procedure.

For example, in some implementations, the “VerifyChat” feature may be utilized for fraud prevention. For example, the SFT PLATFORM may detect an unusual and/or suspicious fund transfer request (e.g., to a suspicious account, etc.). The SFT PLATFORM may utilize the VerifyChat feature to communicate with the user, and verify the authenticity of the originator of the purchase transaction. In various implementations, the SFT PLATFORM may send electronic mail message, text (SMS) messages, Facebook® messages, Twitter™ tweets, text chat, voice chat, video chat (e.g., Apple FaceTime), and/or the like to communicate with the user. For example, the SFT PLATFORM may initiate a video challenge for the user, e.g., 725. For example, the user may need to present him/her-self via a video chat, e.g., 726. In some implementations, a customer service representative, e.g., agent 728b, may manually determine the authenticity of the user using the video of the user. In some implementations, the SFT PLATFORM may utilize face, biometric and/or like recognition (e.g., using pattern classification techniques) to determine the identity of the user, e.g., 728a. In some implementations, the app may provide reference marker (e.g., cross-hairs, target box, etc.), e.g., 727, so that the user may the video to facilitate the SFT PLATFORM's automated recognition of the user. In some implementations, the user may not have initiated the transaction, e.g., the transaction is fraudulent. In such implementations, the user may cancel, e.g., 729, the challenge. The SFT PLATFORM may then cancel the fund transfer request, and/or initiate fraud investigation procedures on behalf of the user.

In some implementations, the user may select to schedule a fund transfer using a one-time anonymized credit card number, e.g., 715b. In such implementations, the app may automatically set the user profile settings such that the any personal identifying information of the user will not be provided to the merchant and/or other entities. In one embodiment, the user may be required to enter a user name and password to enable the one-time anonymization feature.

In some implementations, the SFT PLATFORM may utilize a text challenge procedure to verify the authenticity of the user, e.g., 730. For example, the SFT PLATFORM may communicate with the user via text chat, SMS messages, electronic mail, Facebook® messages, Twitter™ tweets, and/or the like. The SFT PLATFORM may pose a challenge question, e.g., 732, for the user. The app may provide a user input interface element(s) (e.g., virtual keyboard 733) to answer the challenge question posed by the SFT PLATFORM. In some implementations, the challenge question may randomly selected by the SFT PLATFORM automatically; in some implementations, a customer service representative may manually communicate with the user. In some implementations, the user may not have initiated the transaction, e.g., the transaction is fraudulent. In such implementations, the user may cancel, e.g., 731, the text challenge. The SFT PLATFORM may then cancel the transaction, and/or initiate fraud investigation procedures on behalf of the user.

In some implementations, the user may be able to view and/or modify the user profile and/or settings of the user, e.g., by activating user interface element 709 (see FIG. 7A). For example, the user may be able to view/modify a user name (e.g., 735a-b), account number (e.g., 736a-b), user security access code (e.g., 737a-b), user pin (e.g., 738a-b), user address (e.g., 739a-b), social security number associated with the user (e.g., 740a-b), current device GPS location (e.g., 741a-b), user account of the merchant in whose store the user currently is (e.g., 742a-b), the user's rewards accounts (e.g., 743a-b), and/or the like. In some implementations, the user may be able to select which of the data fields and their associated values should be transmitted to facilitate the purchase transaction. For example, in the example illustration in FIG. 7C, the user has selected the name 735a, account number 736a, security code 737a, merchant account ID 742a and rewards account ID 743a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission.

In some implementations, the app may provide the SFT PLATFORM with the GPS location of the user. For example, when a user utilize SFT PLATOFRM for automatic healthcare payment for a scheduled medical procedure (as discussed in FIG. 6), based on the GPS location of the user, the SFT PLATFORM may determine the context of the user (e.g., whether the user is in a doctor's office, hospital, health center, etc.). Based on the context, the user app may present the appropriate fields to the user, from which the user may select fields and/or field values to send as part of the purchase order transmission.

### SFT Platform Controller

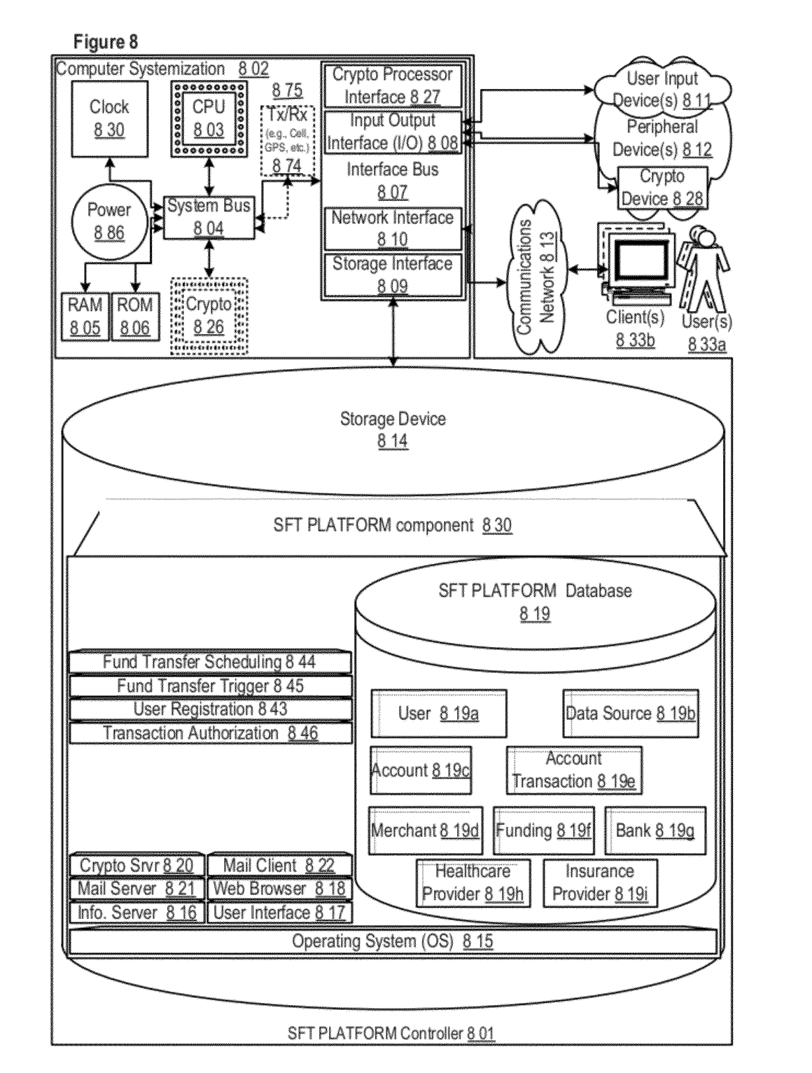

FIG. 8 shows a block diagram illustrating embodiments of a SFT PLATFORM controller. In this embodiment, the SFT PLATFORM controller 801 may serve to aggregate, process, store, search, serve, identify, instruct, generate, match, and/or facilitate interactions with a computer through social network and electronic commerce technologies, and/or other related data.

Typically, users, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to carry and pass encoded (e.g., binary) signals acting as instructions to bring about various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SFT PLATFORM controller 801 may be connected to and/or communicate with entities such as, but not limited to: one or more users from user input devices 811; peripheral devices 812; an optional cryptographic processor device 828; and/or a communications network 813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SFT PLATFORM controller 801 may be based on computer systems that may comprise, but are not limited to, components such as: a computer systemization 802 connected to memory 829.

### Computer Systemization

A computer systemization 802 may comprise a clock 83o, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother)board(s) 802 having conductive and/or otherwise transportive circuit pathways through which instructions (e.g., binary encoded signals) may travel to effectuate communications, operations, storage, etc. The computer systemization may be connected to a power source 886; e.g., optionally the power source may be internal. Optionally, a cryptographic processor 826 and/or transceivers (e.g., ICs) 874 may be connected to the system bus. In another embodiment, the cryptographic processor and/or transceivers may be connected as either internal and/or external peripheral devices 812 via the interface bus I/O. In turn, the transceivers may be connected to antenna(s) 875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SFT PLATFORM controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SFT PLATFORM controller and beyond through various interfaces. Should processing requirements dictate a greater amount speed and/or capacity, distributed processors (e.g., Distributed SFT PLATFORM), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SFT PLATFORM may be achieved by implementing a microcontroller such as CAST's R8051XC2 microcontroller; Intel's MCS 51 (i.e., 8051 microcontroller); and/or the like. Also, to implement certain features of the SFT PLATFORM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SFT PLATFORM component collection (distributed or otherwise) and/or features may be implemented via the microprocessor and/or via embedded components; e.g., via ASIC, coprocessor, DSP, FPGA, and/or the like. Alternately, some implementations of the SFT PLATFORM may be implemented with embedded components that are configured and used to achieve a variety of features or signal processing.

Depending on the particular implementation, the embedded components may include software solutions, hardware solutions, and/or some combination of both hardware/software solutions. For example, SFT PLATFORM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SFT PLATFORM features. A hierarchy of programmable interconnects allow logic blocks to be interconnected as needed by the SFT PLATFORM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SFT PLATFORM may be developed on regular FPGAs and then migrated into a fixed version that more resembles ASIC implementations. Alternate or coordinating implementations may migrate SFT PLATFORM controller features to a final ASIC instead of or in addition to FPGAs. Depending on the implementation all of the aforementioned embedded components and microprocessors may be considered the “CPU” and/or “processor” for the SFT PLATFORM.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the SFT PLATFORM thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the SFT PLATFORM controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SFT PLATFORM), architectures may similarly be employed to pool, load balance, and/or otherwise increase the communicative bandwidth required by the SFT PLATFORM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 811 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 812 may be connected and/or communicate to I/O and/or other facilities of the like such as network interfaces, storage interfaces, directly to the interface bus, system bus, the CPU, and/or the like. Peripheral devices may be external, internal and/or part of the SFT PLATFORM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the SFT PLATFORM controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the SFT PLATFORM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the SFT PLATFORM controller and/or a computer systemization may employ various forms of memory 829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the SFT PLATFORM component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the SFT PLATFORM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with communications networks, data, I/O, peripheral devices, program components, memory, user input devices, and/or the like. The operating system may provide communications protocols that allow the SFT PLATFORM controller to communicate with other entities through a communications network 813. Various communication protocols may be used by the SFT PLATFORM controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SFT PLATFORM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SFT PLATFORM database 819, operating systems, other program components, user interfaces, Web browsers, and/or the like.

Access to the SFT PLATFORM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SFT PLATFORM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SFT PLATFORM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SFT PLATFORM enabled nodes. The combined application may be nugatory on systems employing standard Web browsers.

### Mail Server

A mail server component 821 is a stored program component that is executed by a CPU 803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the SFT PLATFORM.

Access to the SFT PLATFORM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 82o is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SFT PLATFORM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the SFT PLATFORM component to engage in secure transactions if so desired. The cryptographic component facilitates the secure accessing of resources on the SFT PLATFORM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The SFT Platform Database

The SFT PLATFORM database component 819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SFT PLATFORM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SFT PLATFORM database is implemented as a data-structure, the use of the SFT PLATFORM database 819 may be integrated into another component such as the SFT PLATFORM component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 819 includes several tables 819a-i. Users table 819a includes fields such as, but not limited to: a user_id, user_accounts, name, mailing_address_street_name, mailing_address_city, mailing_address_state, mailing_address_zipcode, email_address, phone_number, card_number, user_profiles, and/or the like. The user table may support and/or track multiple entity accounts on a SFT PLATFORM. A Data Sources table 819b includes fields such as, but not limited to: source_id, source_info, source_location and/or the like. An Accounts table 819c includes fields such as, but not limited to: account_id, account_info, account_profile, account_value, PIN, password, security_question, security_answer, card_status, account_status, card_number, available_account_balance, actual_balance, expiration_date, bank_account_type, funds_transfer_frequency, account_description, transfer_to_routing number, transfer_to account_number, account_fraud, account_upgrade_status, account_notes, transaction_status, transaction_fee and/or the like. A Merchants table 9d includes fields such as, but not limited to: merchant_id, merchant_info, merchant_name, merchant_location, merchant_address, merchant_phone_number, merchant_profile, merchant_fee and/or the like. An Account Transaction table 819e includes fields such as, but not limited to: transaction_id, transation_source, transaction_info, user_id, transaction_type, transaction_whitelist (e.g., whitelisted transaction type, etc.), transaction_blacklist (e.g., blacklisted transaction type, etc.), account_id, transaction_date, transaction_time, transaction_action, transaction_action_by, transaction_description, transaction_status, transaction_dispute and/or the like. A Funding Source table 819f includes fields such as, but not limited to: funding_id, funding_info, funding_source, funding_source_name, funding_source_location, funding_deposit_type, funding_schedule, funding_frequency, funding_date, funding_value, funding_amount, funding_restriction, and/or the like. A Banks table 819g includes fields such as, but not limited to: bank_name, bank_id, bank_profile, bank_routing, bank_state, bank_info, bank_note, bank_action, bank_status, routing_number, account_number, and/or the like. A healthcare provider table 819h includes fields such as, but not limited to: HealthcareProviderID, HealthcareProviderName, HealthcareProviderAddress, HealthcareProviderInsured, HealthcareProviderUserID, HealthcareProviderCode, and/or the like. An insurance provider table 819i includes fields such as, but not limited to: InsuranceProviderlD, InsurancePlan, InsurnaceNetwork, InsuranceUserID, InsuranceTransaction, and/or the like.

In one embodiment, the SFT PLATFORM database may interact with other database systems. For example, employing a distributed database system, queries and data access by search SFT PLATFORM component may treat the combination of the SFT PLATFORM database, an integrated data security layer database as a single database entity.

In one embodiment, user programs may contain various user interface primitives, which may serve to update the SFT PLATFORM. Also, various accounts may require custom database tables depending upon the environments and the types of clients the SFT PLATFORM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-i. The SFT PLATFORM may be configured to keep track of various settings, inputs, and parameters via database controllers.

The SFT PLATFORM database may communicate to and/or with other components in a component collection, including itself, and/or facilities of the like. Most frequently, the SFT PLATFORM database communicates with the SFT PLATFORM component, other program components, and/or the like. The database may contain, retain, and provide information regarding other nodes and data.

### The SFT Platforms

The SFT PLATFORM component 835 is a stored program component that is executed by a CPU. In one embodiment, the SFT PLATFORM component incorporates any and/or all combinations of the aspects of the SFT PLATFORM that was discussed in the previous figures. As such, the SFT PLATFORM affects accessing, obtaining and the provision of information, services, transactions, and/or the like across various communications networks.

The SFT PLATFORM transforms user account information, fund transfer configuration inputs via SFT PLATFORM components, such as user registration 843, fund transfer scheduling 844, fund transfer trigger 845, transaction authorization 846, and/or the like into fund transfer transaction record and fund transfer to a transfer-to account.

The SFT PLATFORM component facilitates access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SFT PLATFORM server employs a cryptographic server to encrypt and decrypt communications. The SFT PLATFORM component may communicate to and/or with other components in a component collection, including itself, and/or facilities of the like. Most frequently, the SFT PLATFORM component communicates with the SFT PLATFORM database, operating systems, other program components, and/or the like. The SFT PLATFORM may contain, communicate, generate, obtain, and/or provide program component, system, user, and/or data communications, requests, and/or responses.

### Distributed SFT Platforms

The structure and/or operation of any of the SFT PLATFORM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SFT PLATFORM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the SFT PLATFORM controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until
end of message
do {

$input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password);
// access database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/com.ibm
.IBMDI.doc/referenceguide295.htm

and other parser implementations:

http://publib.boulder.ibm.com/infocenter/tivihelp/v2r1/index.jsp?topic=/com.ibm
.IBMDI.doc/referenceguide259.htm

all of which are hereby expressly incorporated by reference.

In order to address various issues and advance the art, the entirety of this application for SCHEDULED FUNDS TRANSFER PLATFORM APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural ad/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SFT PLATFORM individual and/or enterprise user, database configuration and/or relational model, data type, data transmission and/or network framework, syntax structure, and/or the like, various embodiments of the SFT PLATFORM, may be implemented that facilitates a great deal of flexibility and customization. While various embodiments and discussions of the SFT PLATFORM have been directed to social networks, however, it is to be understood that the embodiments described herein may be readily configured and/or customized for a wide variety of other applications and/or implementations.

What is claimed is:

1. A processor-implemented fund transfer scheduling method, comprising:
receiving a fund transfer scheduling request and fund transfer configuration parameters from a user,
said fund transfer configuration parameters including a fund transfer trigger condition, a fund transferor's account and a fund transferee's account;
verifying eligibility of the fund transfer scheduling request based on the fund transfer configuration parameters;
determining the fund transfer trigger condition occurs;
initiating a fund transfer transaction from the fund transferor's account to the fund transferee's account; and
generating a fund transfer transaction record based on the initiated fund transfer transaction.

2. The method of claim 1, wherein the user is a cardholder.

3. The method of claim 1, wherein the fund transfer trigger condition includes fund loading into the fund transferor's account.

4. The method of claim 1, wherein the fund transferor's account is a prepaid account.

5. The method of claim 1, wherein the fund transferor's account comprises any of a prepaid credit card and a prepaid debit card.

6. The method of claim 1, wherein the fund transferor's account is one of a checking account and a savings account.

7. The method of claim 1, wherein fund transfer configuration parameters further include a type of the fund transfer.

8. The method of claim 7, wherein the fund transfer is a one-time scheduled fund transfer.

9. The method of claim 7, wherein the fund transfer is a recurring fund transfer.

10. The method of claim 1, wherein the fund transfer configuration parameters further comprises a fund transfer amount.

11. The method of claim 1, wherein verifying eligibility comprises:
determining whether a fund transfer amount exceeds fund availability in the transferor's account.

12. The method of claim 1, wherein verifying eligibility comprises:
determining whether a transferee's account is valid.

13. The method of claim 1, further comprising:
generating an error message when the fun transfer scheduling request is invalid.

14. The method of claim 1, further comprising:
generating an ACH credit to the transferee's account; and
debiting the transferor's account.

15. The method of claim 1, further comprising:
incrementing a count for ACH records process billing code to record the fund transfer transaction.

16. The method of claim 1, further comprising:
adding a note in the transferor's account history indicating the fund transfer transaction.

17. The method of claim 1, further comprising:
sending a funds transfer requested email to an email address in the user's profile.

18. The method of claim 1, wherein the fund transfer transaction record is in a format compliant with an ACH file.

19. The method of claim 1, wherein the fund transfer request comprises a payment for a scheduled medical procedure.

20. The method of claim 19, further comprising:
receiving information with regard to a scheduled medical procedure including an estimate of an payment amount.

21. The method of claim 19, further comprising:
retrieve a previously stored prepaid authorization record related to the received patient medical treatment information; and
verifying the received medical payment request with the previously stored prepaid authorization record.

22. The method of claim 21, wherein the verification is performed by a third party.

23. The method of claim 22, wherein the third party is a healthcare insurance carrier.

24. The method of claim 19, further comprising: authorizing a verified prepaid amount payment from an insurance provider to the healthcare provider.

25. A processor-implemented fund transfer scheduling method, comprising:
receiving account data associated with a prepaid cardholder;
validating the account data;
processing financial requirements associated with the account data and cardholder;
processing transactional requirements associated with the account data and cardholder;
processing jurisdiction requirements associated with the account data and cardholder;
processing regulatory requirements associated with the account data and cardholder;
determining funds transfer allowance from the processed account data;
receiving data associated with a transfer-to account, wherein the transfer-to account may be a checking or savings account;
validating transfer-to account data;
determining a funds transfer and funds transfer type, wherein funds transfer type may be one-time or recurring; and
processing the funds transfer.

26. A scheduled funds transfer apparatus, comprising:
a memory;
a processor disposed in communication with said memory, and configured to issue a plurality of processing instructions stored in the memory, wherein the process issues instructions to:
receive a fund transfer scheduling request and fund transfer configuration parameters from a user,
said fund transfer configuration parameters including a fund transfer trigger condition, a fund transferor's account and a fund transferee's account;
verify eligibility of the fund transfer scheduling request based on the fund transfer configuration parameters;
determine the fund transfer trigger condition occurs;
initiate a fund transfer transaction from the fund transferor's account to the fund transferee's account; and
generate a fund transfer transaction record based on the initiated fund transfer transaction.

27. A processor-readable medium storing processor-issuable instructions to:
receive a fund transfer scheduling request and fund transfer configuration parameters from a user,
said fund transfer configuration parameters including a fund transfer trigger condition, a fund transferor's account and a fund transferee's account;
verify eligibility of the fund transfer scheduling request based on the fund transfer configuration parameters;
determine the fund transfer trigger condition occurs;
initiate a fund transfer transaction from the fund transferor's account to the fund transferee's account; and
generate a fund transfer transaction record based on the initiated fund transfer transaction.
